(19) United States
(12) Patent Application Publication
(10) Pub. No.: US 2006/0036647 A1
(43) Pub. Date: Feb. 16, 2006

(54) System, method, and apparatus for exchanging information between employers, institutions, and employment seekers

(76) Inventors: Henry A. Fichtner, Neconset, NY (US); Robert S. Green, Quakertown, PA (US)

Correspondence Address: KENYON & KENYON, ONE BROADWAY, NEW YORK, NY, 10004, US

(21) Appl. No.: 11/147,009

(22) Filed: Jun. 6, 2005

Related U.S. Application Data
(60) Provisional application No. 60/577,769, filed on Jun. 7, 2004.

(51) Int. Cl. G06F 17/00

(52) U.S. Cl. 707/104.1

(57) ABSTRACT

A system, method, and apparatus are provided to facilitate the exchange of multimedia-formatted information between an employer and an employment seeker, in which the information is provided in a multimedia format, in which the multimedia-formatted information is received from the employment seeker via a station, the multimedia-formatted information is uploaded from the station to a data center via a first communications network, and the employer is provided with access to the multimedia-formatted information via a second communications network.

### RELATED APPLICATIONS

This application claims the benefit and priority under 35 U.S.C. § 119 of U.S. Provisional Patent Application Ser. No. 60/577,769, filed Jun. 7, 2004, which is incorporated herein by reference in its entirety.

### FIELD OF THE INVENTION

The present invention relates to a system, method, and apparatus to facilitate the exchange of information between employers, institutions, and employment seekers.

### BACKGROUND INFORMATION

An employer may solicit candidates for employment, for example, by requesting resumes of those seeking employment who are associated with an institution, such as a university, reviewing the resumes, scheduling on-campus interviews, and dispatching one or more recruiters to the campus to perform the interviews. The process may be costly in both time and effort, and may not yield suitable candidates for employment. Moreover, the number of on-campus interviews that a recruiter can attend at a particular location may be limited.

Candidates for employment are likewise limited in their time and effort, and the current interview process may not provide an adequate opportunity to be interviewed. Moreover, some candidates may find the conventional interview process to be a waste of their time.

Institutions may also be limited in the amount of resources they can devote to facilitate the interview process. Institutions may also find it difficult to attract employers on behalf of their students, especially if the employer is distantly located from the university campus.

Traditional resumes may show a candidates' educational background and work experience, but fail to show verbal communication skills, presentation capabilities, persona and organizational fit. When combining these skills with educational background and former work experience, recruiters truly have a complete picture of a qualified candidate.

### SUMMARY OF THE INVENTION

The present invention provides a system, method, and apparatus to facilitate the exchange of information between employers, institutions, and employment seekers. The information may be made available at any time and at any suitable location, and may be accessed repeatedly by the same or multiple entities. Moreover, the information may be provided in wide variety of formats including, but not limited to, multimedia formats.

According to an exemplary embodiment of the present invention, the information may be digitally recorded, stored, and retrieved via one or more stations, and may include, for example, any information regarding the employer, institution, and/or the employment seeker. In particular, the information may include, for example, interviews, documentation, personal contact information, credentials, etc., and may be provided in a multimedia format that includes, graphics, text, audio, video, etc.

According to an exemplary embodiment of the present invention, employment seekers may record audio/video data via a station, such as a kiosk terminal made available to the employment seekers or to the general public, and may upload additional data via a private station, such as a personal computer. The audio/video recording and uploaded data may be organized in a customizable Web-space, also referred to as a Web portfolio, which may be made accessible to one or more employers. The employers, in turn, may provide their own Web-space with information related to potential job opportunities or other information.

According to an exemplary embodiment of the present invention, one or more customizable video profiles and question/answer interviews are created to visually evaluate and screen a more complete view of a candidate before further time and monetary investments are made. In this regard, a maximize number of qualified candidates may be advanced during the screening process, certain candidate skills may be ascertained, which may not be determined by a traditional resume, the process of comparing and assessing candidates may be more standardized, and efficiency of recruiting efforts may be enhanced.

### BRIEF DESCRIPTION OF THE DRAWINGS

FIGS. 1A and 1B show an exemplary system to facilitate the exchange of information between an employment seeker, a representative of an institution, and a representative of the employer.

FIG. 2 shows an exemplary process flow for the employment seeker, the representative of the institution, and the representative of the employer of FIGS. 1A and 1B.

FIG. 3 shows an exemplary method to create a personal Web space.

FIG. 4 shows an exemplary user interface for the public station of FIGS. 1A and 1B.

FIG. 5 shows an exemplary method of interacting with the exemplary system of FIGS. 1A and 1B.

FIG. 6 shows an exemplary partnership arrangement and method to facilitate the exchange of information regarding members of the partnership.

FIG. 7 shows an exemplary arrangement of the public station of FIGS. 1A and 1B.

FIG. 8 shows an exemplary method for exchanging information between and employer and an employment seeker, from the perspective of the employer.

FIG. 9 shows an exemplary method for exchanging information between an employer and an employment seeker, from the perspective of the employment seeker.

FIG. 10 shows an exemplary login screen to enter username and password information required to access the system.

FIG. 11 shows an exemplary forgot password screen, which is presented upon access the “Forgot your password?” link of the exemplary login screen of FIG. 10.

FIG. 12 shows an exemplary manage-search candidates screen to manage and search candidate information.

FIG. 13 shows an exemplary create candidate screen to create a candidate profile.

FIG. 14 shows an exemplary create confirm candidate screen to confirm the information entered in the exemplary create candidate screen of FIG. 13.

FIG. 15 shows an exemplary edit candidate screen to edit a candidate profile.

FIG. 16 shows an exemplary edit confirm candidate screen to confirm information entered in the exemplary edit candidate screen of FIG. 15.

FIG. 17 shows an exemplary candidate edit successful screen to indicate a successful edit of candidate profile information.

FIG. 18 shows an exemplary manage questions screen to enter and/or rearrange the order of questions presented to the candidate.

FIG. 19 shows an exemplary manage preview video screen to manage and/or preview of video.

FIG. 20 shows an exemplary email video link screen to send create and send an email invitation.

FIG. 21 shows an exemplary change password screen to change a password associated with a particular user.

FIG. 22 shows an exemplary help screen to provide on-line assistance.

FIG. 23 shows an exemplary login screen to access a kiosk station for purpose, for example, of recording a video by an employment seeker.

FIG. 24 shows an exemplary disclaimer/waiver screen to display disclaimer and/or waiver information, and to receive an accept or decline indication from the user.

FIG. 25 shows an exemplary prerecording instruction and setup screen to instruct the user regarding the operation of the kiosk station, including adjustments prior to commencement of recording.

FIG. 26 shows an exemplary countdown screen to provide a countdown display prior to the start of the recording process.

FIG. 27 shows an exemplary teleprompter/question presentation screen to display a list of questions intended to solicit specific responses from the user.

FIG. 28 shows an exemplary post recording screen to optionally review, accept, re-record, or cancel a recorded video.

FIG. 29 shows an exemplary logout screen to provide a proper notice to the user that the kiosk station session has ended.

FIG. 30 shows a schematic illustration in front view of an exemplary kiosk station.

FIG. 31 shows an schematic illustration in side view of the exemplary kiosk station of FIG. 30.

### DETAILED DESCRIPTION

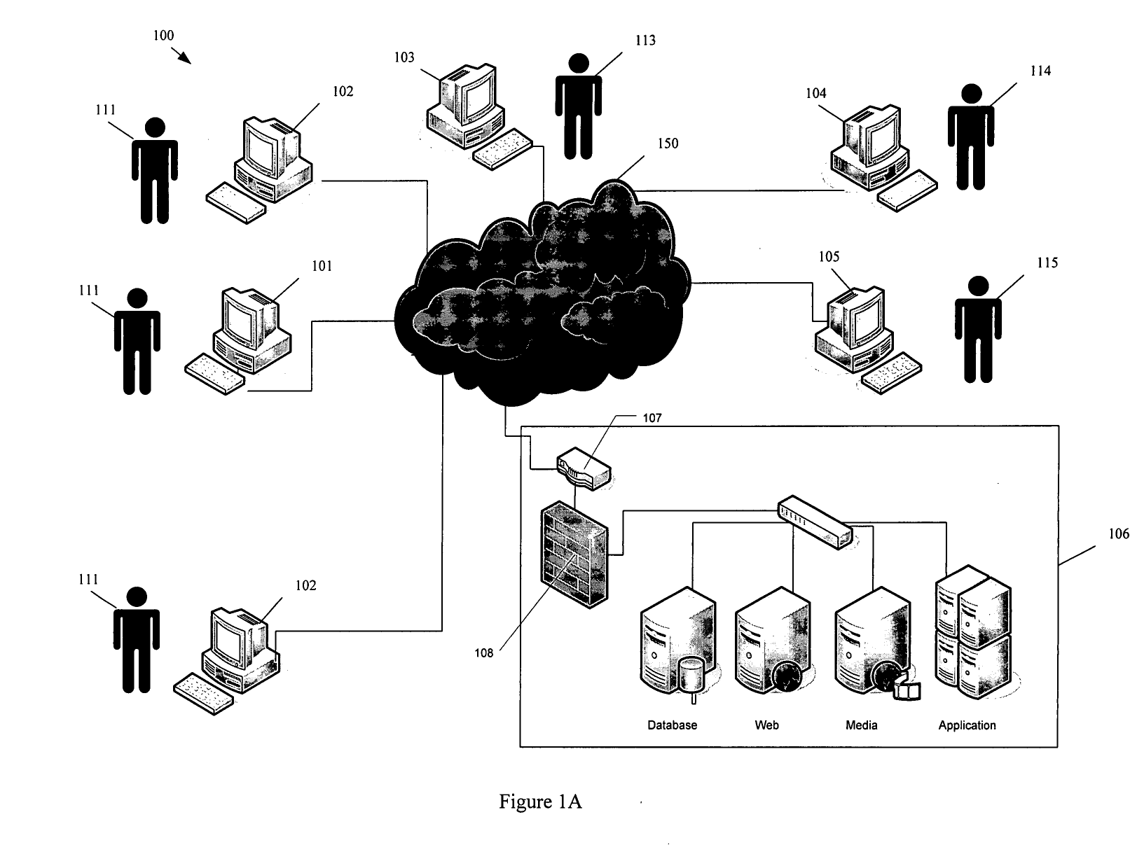

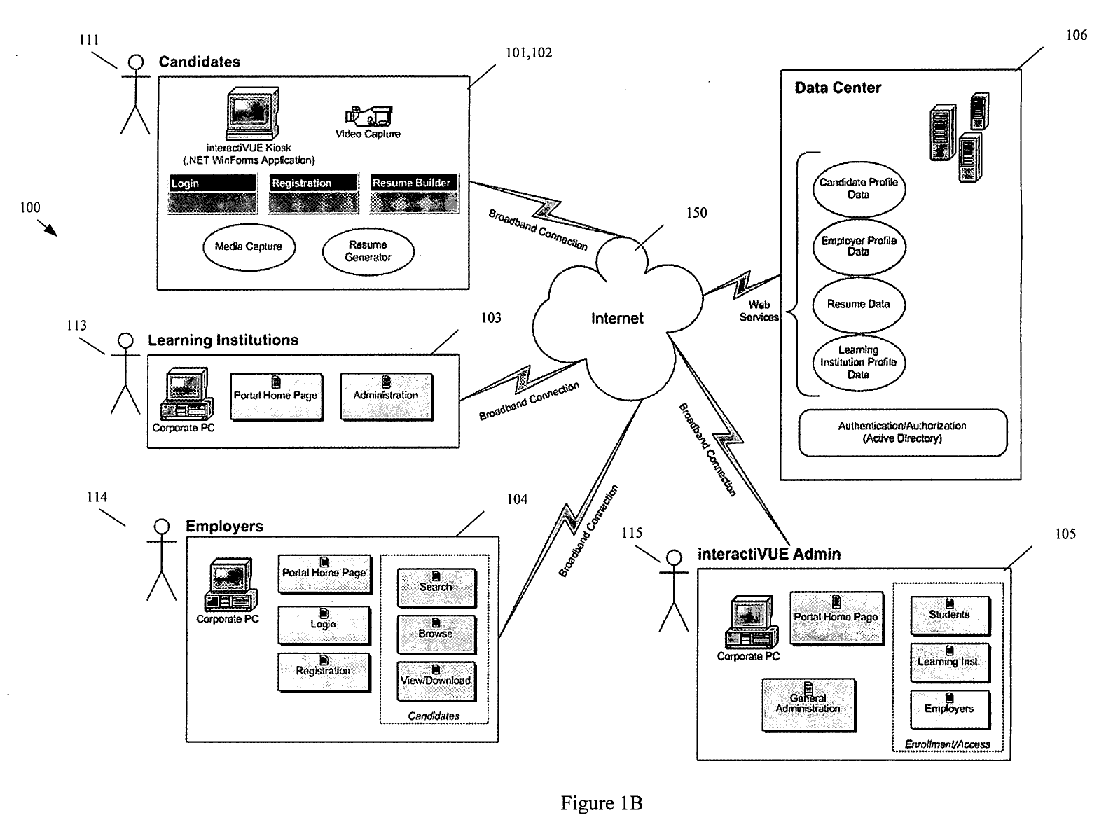

FIGS. 1A and 1B show an exemplary system 100 to facilitate the exchange of information between an employment seeker 111, a representative 113 of an institution, and a representative 114 of an employer. The employment seeker 111 may be any person seeking employment, including, for example, an unemployed worker or an employed worker seeking further employment opportunities. The employment seeker 111 may also be, for example, a student enrolled at the institution.

The institution may be, for example, a learning institution, such as a college or university, or a sub-unit of the learning institution such as a career services unit. The representative 113 of the institution may be, for example, a specialist involved with the career services unit. The institution may also be, for example, a vocational school, such as a beauty school or technical high school, a workers union, a temp agency, or any other institution having an association with potential employment seekers.

The employer may be any entity providing employment, including, for example, a person, a private business, a government agency, a non-profit organization, an institution, etc. The employment may include, for example, present and/or future employment, and may be temporary and/or permanent. The representative 114 of the employer may be, for example, a recruiter.

The exemplary system 100 includes a public station 101, a private station 102, an institution station 103, an employer station 104, an administration station 105, and a data center 106. The stations 101-105 and data center 106 may be interconnected via a network 150 using, for example, broad band communications. The network 150 may include, for example, the Internet or any other communications network.

The public station 101 provides access to the system 100 by the employment seeker 111. In this regard, the access may be provided in a public setting, such as, for example, a public area of a university campus, or a semi-public area reserved for certain employment seekers, such as those associated with the university or a subset thereof. Moreover, the access may be provided in a physically secure location, such as, for example, a university computer room.

The public station 101 may provide to the employment seeker 111 the ability to access multimedia features of the system 100, which include, for example, the recording and/or playback of audio/video recording images. In particular, the public station 101 may include a video capture unit to capture a video image of the employment seeker 111, or an audio capture unit to capture an audio signal associated with the employment seeker 111. The public station 101 may also include an interface to upload pre-recorded data, such as may be provided, for example, on magnetic recording media, CD, or DVD. In this regard, the interface may include, for example, a CD ROM drive, DVD player, and/or USB port. The interface may also include, for example, a scanner to scan paper documents, such as a resume or writing sample.

The public station 101 may be configured, for example, as a kiosk having a simplified user interface (UI). In this regard, the employment seeker 111 may not be required, for example, to possess special skills to interact with the public station 100. The user interface (UI) may include, for example, a virtual keyboard or touch screen interface, and may be implemented, for example, as a Microsoft Windows user interface or any other suitable application having interactive and/or multimedia capabilities.

The public station 101 may also be configured as mobile device so that the public station 101 may be flexibly provided at any desired location and therefore accessible to many employment seekers. In this regard, the public station 101 may be implemented, for example, as a movable kiosk station or a suitably equipped laptop computer. The public station 101 may include, for example, a wireless interface, which supports a standardized wireless protocol, including, for example, Bluetooth or the 802.11 a/b/g wireless standards provided by the Institute of Electrical and Electronics Engineers (IEEE), sometimes referred to as Wi-Fi. Hence, the public station 101 may be movably located, for example, to any desired location.

The public station 101 may also serve as a marketing device to advertise the services of the system 100 and to provide information to the employment seeker 111 regarding the features and benefits of the system 100, as well as requirements and/or restrictions of use. In this regard, the public station 101 may include, for example, features to attract the attention of the employment seeker 111. The features may include, for example, flashing lights, sound, moving signs, scrolling electronic billboard signs, cathode ray tube (CRT) monitor displays, and liquid crystal display (LCD) projectors. The public station 101 may also display marketing trade names and/or logos. It will be appreciated that the public station 101 may serve as a marketing device for employers, institutions, or other entities as well. In particular, the advertising displayed by the public station 101 may be reserved, for example, for a special class of employers, such as a “gold” or “platinum” class of employers whose subscription to the service of the system 100 entitles them to certain marketing services.

The private station 102 provides further access to the system 100 by the employment seeker 111 in a private or semi-private setting. The private station 102 may be, for example, a personal computer running an application of the system 100, and may be owned, for example, by the employment seeker 111. Alternatively, the institution may own and maintain the personal computer. The connection to the system 100 may include, for example, an Internet connection.

The private station 102 may provide to the employment seeker 111 the ability search posted job listings, which may be provided, for example, as part of an employer-specific Web space. In this regard, the employer-specific Web space may include, for example, a listing of employment opportunities, salary information, qualifications required for the employment, or any other suitable information regarding the employment opportunities. The employer-specific Web space may also include, for example, information related to the employer in general. It will be appreciated that the information regarding employment opportunities or general information may be provided in any multimedia format, such as an audio/video presentation.

The ability to search posted job listings may further include an ability to discriminate the search according to certain criteria. For example, the employment seeker 111 may limit the search by specifying a certain geographic area (e.g., city or state), industry type (e.g., telecommunications), job description (e.g., marketing), salary requirement (e.g., no less than $50,000 with 401K benefits and 15 days of paid vacation), employer (e.g., ABC Corp.), etc. Moreover, the search may be configured to exclude the job listings previously examined by the employment seeker 111.

The private station 102 may also provide to the employment seeker 111 the ability to respond to posted job listings. In this regard, the private station 102 may provide to the employment seeker 111 the ability to upload files and/or data, including, for example, a resume, a writing sample, a letter of recommendation, a video file, an audio file, or any other data related to employer seeker 111 and/or their qualifications. The resume, writing sample, letter of recommendation, and other documentation may be provided in any standardized format, including, for example, Microsoft Word format, Portable Document Format (pdf), Excel, and WordPerfect format. Likewise, the audio and/or video files may also conform to a standardized format, such as, for example, the Audio Video Interleaved (AVI) format, the Microsoft Wave File format, the Joint Photographic Experts Group (JPEG) format, the Moving Pictures Experts Group (MPEG) format (e.g., MP3), or any other suitable compression format that allows storage and manipulation of multimedia content.

The private station 102 may also provide to the employment seeker 111 the ability to upload one or more videos, which were previously recorded, for example, via the public station 101. The one or more videos may include, for example, an introduction video, an interview video, and/or any other suitable video interview format. It will be appreciated that the quantity and type of videos may be restricted and/or screened by the institution. It will also be appreciated that some or all of the capabilities and functions provided by the public station 101 may be provided by the private station 102 as well, and vice versa.

The private station 102 may be implemented, for example, as a secure Web-based application, which may accessible to one or more users of the system 100. The Web-based application may include features available in programming languages, such as, for example, ASP, Java, JavaScript, Coldfusion, Frontpage, .NET, Visual Basic, Visual C++, Visual C#, or any other Microsoft .NET language.

The private station 102 may also provide access to an enrollment/registration application of the system 100 so that the employment seeker 111 may obtain certain services of the system 100 as defined, for example, by an agreement or contract between the employment seeker 111 and representatives or agents of the institution, employer, or system 100. In this regard, the services may include, for example, the ability to create a personal Web space, access recorded videos, and respond to job postings. It will be appreciated that the enrollment/registration application may require the employment seeker 111 to supply certain information, such as, for example, an identifier and password, an email address, a telephone number, etc.

The institution station 103 provides access to the system 100 by the representative 113 of an institution. In particular, the institution station 103 may provide to the representative 113 the ability to access job listings and employer/employment seeker profiles for the purpose of facilitating, monitoring, and/or controlling the flow of information. The job listings may be targeted, for example, to institutional members entitled to certain institutional services. In particular, the job listings may be targeted, for example, to students of a university who may be entitled to the services of a career services department of the university.

The institution station 103 may also provide to the representative 113 of the institution the ability to review information supplied by either the recruiter 114 or the employment seeker 111 to ensure, for example, compliance with certain policies and procedures of the institution. For example, the representative 113 of the institution may review a student and/or employer profile or job listing to ensure it does not include offensive, misleading, or inappropriate material. The representative 113 of the institution may also, for example, use the institution station 103 to maintain certain employment and/or employment seeker statistics.

The institution station 103 may also provide alerts on selective postings. The alert may, for example, be in the form of an email message, voice mail, Blackberry alert, page alert, or notification board. It will be appreciated that the alert may be provided in other forms as well.

The employer station 104 provides access to the system 100 by the representative 114 of the employer. In particular, the employer station 104 may provide to the representative 114 the ability to post job listings in the system 100. In this regard, the posted job listings may be categorized, for example, according to one or more targeted categories, including, for example, a particular school or a particular major.

The employer station 104 may also provide to the representative 133 the ability to search listings of employment seekers, which are maintained by the system 100. In this regard, the search may specify certain parameters according to, for example, a demographic or a keyword search. The listings may include, for example, an employment seeker profile. The employment seeker profile may include, for example, a resume and a recorded video.

The employer station 104 may also provide access to an employer-specific home page so that the representative 113 of the employer may manage the posted job listings and related promotions (e.g., Web pop-ups, banner ads, email, instant messages, etc.), which may be targeted, for example, to certain employment seekers. In particular, the employers-specific home page may include, for example, advertising and promotional information intended to highlight certain information regarding the employer or an affiliate thereof. The advertising and promotional information may also highlight information unrelated to the employer as well, including, for example, information regarding third parties. It will be appreciated that the institution may be provided with the ability to restrict certain advertising or promotional information appearing on the employer-specific home page.

The administration station 105 provides access to the system 100 by an administrator 115 of the system 100. The administrator 115 may include, for example, a representative or employee of an organization that owns, manages, and/or provides the system 100.

The administration station 105 provides to the administrator 115 the ability to manage the system 100. In this regard, the administrator 115 may create and manage employment seeker and/or employer accounts, process payment for use of the system 100, and manage content of employment seeker and/or employer homepages associated with the system 100.

The administration station 105 also provides to the administrator 115 the ability to monitor resources of the system 100 and take appropriate actions when required. In this regard, the administration station 105 may provide to the administrator 115 access to the data center 106.

The data center 106 provides a repository for employment seeker profile data (a.k.a. candidate profile data), employer profile data, resume data, and institution profile data. The data may be stored, for example, using commercially available database software, such as the Structured Query Language (SQL) database system. The data center 106 may be configured, for example, as a single or distributed system, and may include, for example, routing equipment 107 (e.g., UUNet router). The data center 106 may also be configured to provide to authorized entities access to all or part of the data.

The data center 106 may utilize authentication and/or authorization techniques to ensure system and data integrity. In particular, the data center 106 may utilize Active Directory, Secure Socket Layer (SSL), Public/Private Key encryption methods, smart card readers, credit card verification methods, etc. The data center 106 may also include a firewall arrangement 108, such as, for example, a Fortinet Firewall.

The system 100 may require registration by the employment seeker 111, the representative 113 of the institution, and/or the representative 114 of the employer to access the system 100. In this regard, accounts of the system 100 may be maintained, including, for example, an employment seeker account, an institution/institution representative account, and an employer/employer representative account, and an administrator account. The system 100 may require the use of passwords to access the system 100 and/or resources associated with a particular account(s).

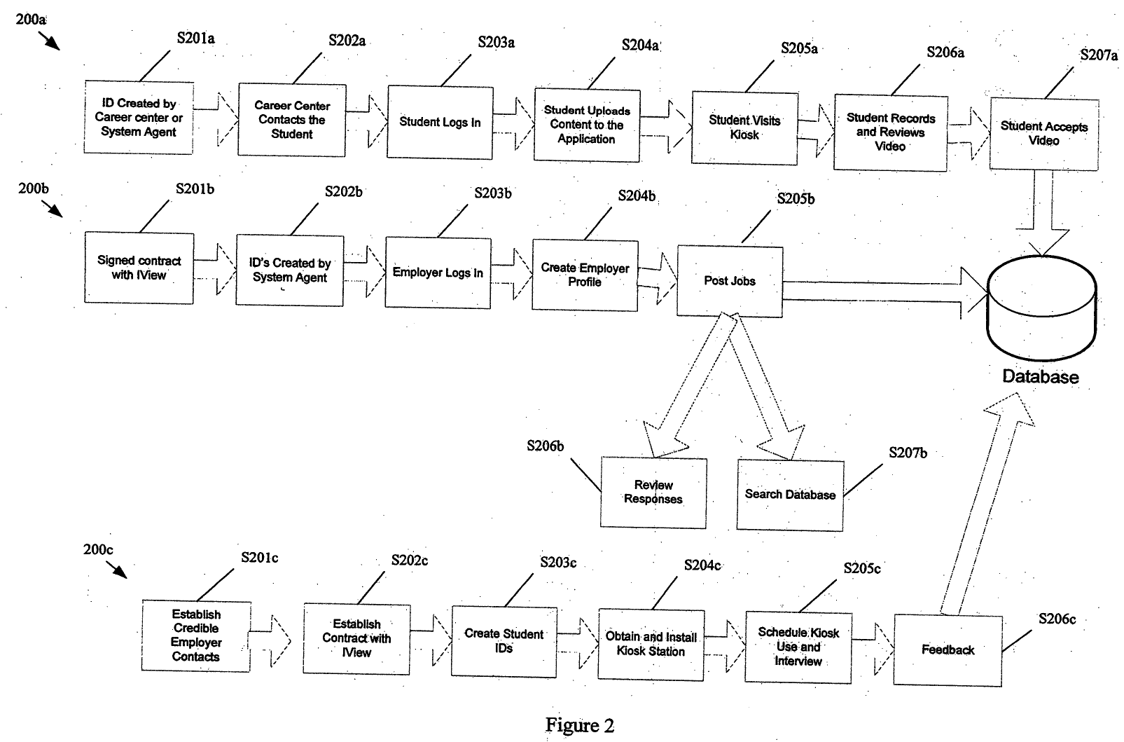

FIG. 2 shows exemplary methods and/or process flows 200a, 200b, and 200c for the employment seeker 111, the representative 113 of the institution, and the representative 144 of the employer, respectively. It will be appreciated that the steps of the exemplary methods and/or process flows 200a, 200b, and 200c, may be logically varied and therefore performed in any required order.

In step S201a, an identifier (ID) is created. In this regard, the identifier (ID) may be created, for example, by the institution or its representative 113 via the institution station 103. In this instance, the institution may be, for example, a career center of a university. Alternatively, an agent or representative of the system 100 may create the identifier (ID) via the administrator station 105. The agent or representative may be, for example, the system administrator 115. It will be appreciated that the identifier (ID) may be unique, for example, for all employment seekers.

In step S202a, the student 111 is contacted by the institution to supply the identifier (ID) to the student 111. In this regard, the student 111 may be contacted, for example, via telephone, email, or any other suitable mode of communication. It will be appreciated that appropriate measures may be taken to ensure the confidentiality of the student 111 and/or the supplied identifier (ID).

In step S203a, the student 111 logs into the system 100 via the private station 102 using the supplied identifier (ID). In this regard, the student 111 may be required to provide a password, which is supplied, for example, by the representative 113 of the institution. Alternatively, the password may be supplied, for example, by the private station 102, an intermediate network element of the exemplary system 100, or the student 111.

In step S204a, the student 111 uploads content to an application of the system 100, which may include, for example, a resume, a writing sample, a letter of recommendation, one or more video files, one or more audio files, presentations, documents, and/or any other suitable information. The content may be provided in a wide variety of multimedia formats, and may be converted into another format prior to upload. For example, the one or more video files may be compressed prior to upload according to any suitable standardized compression algorithm.

In step S205a, the student 111 visits the public station 101. In this instance, the public station 101 may be, for example, a kiosk located on the university campus. The public station 101 may also be the private station 102 if suitably equipped with video and/or audio capture equipment. It will be appreciated that the public and private stations may include similar or identical capabilities or functions.

In step S206a, the student 111 records and reviews a video. It is understood that the student 111 may re-record the video multiple times if desired, and that the student 111 may be provided with the option to erase all or a portion of the recorded video if desired. In this regard, suitable video edit tools may be provided.

In step S207a, the student 111 accepts the video, which is sent to a database residing, for example, in the data center 106. In this regard, the video may be sent using any suitable communications protocol, including, for example, a wireless and/or wired communications protocol. It is understood that the recorded videos may be sent in real-time or in batch mode at a predefined time or interval.

In step S201b, the employer or its representative 114 contracts with an agent or representative of the system 100 to provide services of the system 100.

In step S202b, an identifier (ID) is created on behalf of the employer and/or its representative 114. In this regard, the identifier (ID) may be created, for example, by the system administrator 115 via the administration station 105. The identifier (ID) may include, for example, a student identifier or other institution-generated identifier related to the student 111. It will be appreciated that the identifier (ID) may be unique among all students and/or employment seekers.

In step S203b, the representative 114 of the employer logs into the system 100 via the employer station 104 using the identifier (ID) created on its behalf. A password may be required as well.

In step S204b, an employer profile is created, which includes, for example, information regarding the employer such as size, location, or type of employer. The employer profile may be created, for example, as part of an employer-specific Web space and the information provided therewith may be in any suitable multimedia format. In particular, the information provided with the employer-specific Web space may include text, graphics, audio, and/or video (e.g., a general informational video or a video tailored to a specific employment opportunity).

In step S205b, the representative 114 of the employer posts one or more job listings in the system 100 via the employer station 104. The job listings may be stored, for example, in a database residing in the data center 106. In this regard, the job listing may include, for example, a video presentation or an interactive video.

In step S206b, the representative 114 of the employer reviews responses to the posted job listings. In this regard, the responses may be viewed at the employer station 104. The response may include, for example, an email message with a link to the sender's personal Web space. It will be appreciated that the representative 114 of the employer may review the responses at any time and in any order, or repeatedly if desired.

In step S207b, the representative 114 of the employer searches a database of the system 100 for candidate listings. It will be appreciated that access to the candidate listings or any part thereof by the representative 114 may be restricted according to certain criteria, including, for example, criteria defined in a negotiated contract. In particular, the access to certain candidate listings may be restricted according to an agreement between the employer and the institution and/or an agent of the system 100. The access to the candidate listings may also be restricted, for example, according to a system policy.

In step S201c, the institution establishes a credible employer contact. In this regard, the institution may establish certain procedures and measures to ensure that the employer is reputable and compliant with policy and procedures of the institution.

In step S202c, the institution contracts with an agent or representative of the system 100 to access the services of the system 100. In particular, the institution may contract with the agent “face-to-face”, via telephone, email, or any other suitable mode of communication. It will be appreciated that the agent may be, for example, computer-implemented, such as a Web interface.

In step S203c, a representative 113 of the institution creates one or more identifiers (IDs) on behalf of one or more students 111 associated with the institution.

In step S204c, the institution obtains and installs a public station 101 so that the students 111 may access the system 100 to record a video, for example. In this instance, the public station 101 may be, for example, a kiosk station. It will be appreciated that the public station 101 may be provided, for example, as a stand-alone system. Alternatively, the public station 101 may be provided, for example, as a software package with or without associated recording equipment. It will also be appreciated that the public station 101 may be equipped with third-party software.

In step S205c, the institution schedules use of the public station 101 and one or more interviews. In this context, an interview may be, for example, the video recording of the student 111. The interview may be conducted in “freestyle” format where the student simply records a generalized response. Alternatively, the interview may involve the student 111 responding to specific questions. It will be appreciated that interviews may be provided in other forms as well. It will be further appreciated that the interviews may be conducted in a flexible manner, essentially at any time, including, for example, nights, weekends, holidays, etc. Moreover, interviews may be conducted nearly immediately upon a new job being posted.

In step S206c, feedback is provided. In this context, feedback may be provided from a representative of the employer and/or the institution. For example, the representative 114 of the employer may provide feedback as an email to inform the student 111 of an offer, rejection, or consideration status. Alternatively or additionally, the representative 113 of the institution may provide a review of the interview to critique and coach the student 111. It will be appreciated that the review of the interview by the representative 113 of the institution may provide a screening function to prevent misinformation or abuse by the student 111.

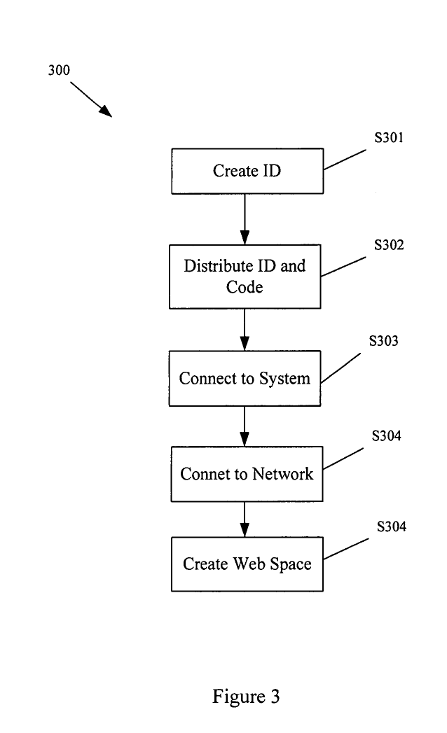

FIG. 3 shows an exemplary method 300 to create a personal Web space for the employment seeker 111. In this regard, the employment seeker 111 may be, for example, a university student. It will be appreciated that the steps of the exemplary method 300 may be logically varied and therefore performed in any required order. It will also be appreciated that the exemplary method 300 to create a personal Web space for the employment seeker 111 may also be applicable to the creation of a Web space for the employer.

In step S301, a unique identifier is created. In this regard, the unique identifier may be, created, for example, by the institution. The unique identifier may be used, for example, to facilitate a login, registration, or enrollment of the employment seeker 111.

In step S302, the unique identifier and a password code are distributed to the employment seeker 111. The unique identifier and password may be distributed, for example, via an email to the employment seeker 111.

In step S303, the employment seeker 111 connects to the system 100. In this regard, the employment seeker 111 may connect to the system 100, for example, via the private station 102. The private station 102 may be, for example, a personal computer running an application of the system 100. The personal computer may be owned, for example, by the employment seeker 111. Alternatively, the institution may own and maintain the personal computer. The connection to the system 100 may include, for example, an Internet connection.

In step S304, a personal Web space is created for the employment seeker 111. The Web space may include information in multiple multimedia formats. In this regard, the Web space may include, for example, an introductory letter, a resume, a video, an audio recording, a Web link, Web pages, other documents and marketing communication tools. The introductory letter may be, for example, audio or text-based. The resume may be, for example, text-based. The video may be, for example, a recording of the employment seeker 111. The audio recording may be, for example, a recording of the employment seeker 111 and may be associated with the video so that they may be played simultaneously. The other documents may include, for example, audio-based resumes, web links, personal information, contact data, or any other associated data.

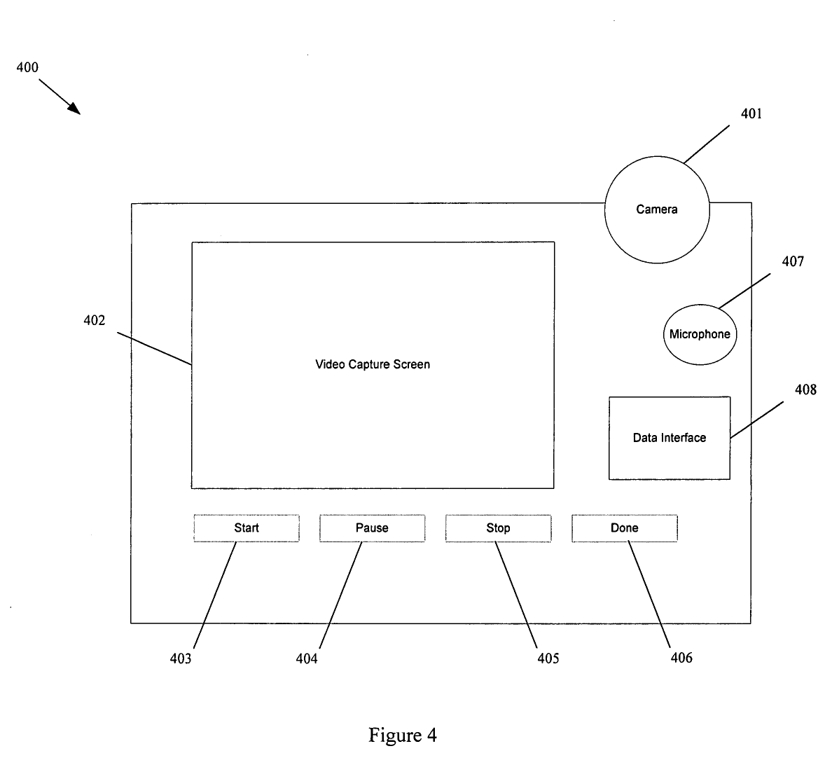

FIG. 4 shows an exemplary user interface 400 for the public station 101. In this regard, the public station 101 may be, for example, a kiosk. The exemplary user interface 400 includes a camera 401, a video capture screen 402, a microphone 407, a data interface 408, a Start button 403, a Pause button 404, a Stop button 405, and a Done button 406. The camera 401 may be, for example, any suitably equipped digital camera, which may be configured to record still images and/or video. The video capture screen may be, for example, any suitably equipped computer monitor or television screen. The data interface 408 may be implemented, for example, as a cassette/CD/DVD player, digital scanner, USB port or any other suitable arrangement to accommodate data input. The buttons 403-406 may be implemented in any suitable manner including, for example, as soft keys, physical buttons, joystick, pointer device, etc. It will be appreciated that the user interface 400 may be provided with additional or fewer buttons as required. For example, according to another exemplary embodiment, the user interface 400 may further include a Submit button. It will also be appreciated that the user interface 400 may include multiple screens divided, for example, between a main screen and one or more sub-screens. It will be further appreciated that the user interface 400 may be applicable to the private station 102 as well, in particular, a private station with audio/video recording capabilities.

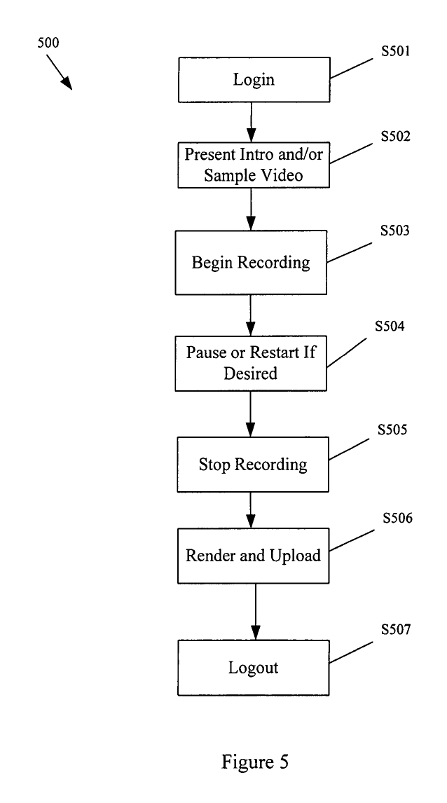

FIG. 5 shows an exemplary method 500 of interaction of the employment seeker 111, the public station 101, and a main application of the system 100. In this regard, the main application may reside, for example, in the data center 106. It will be appreciated that the steps of the exemplary method 500 may be logically varied and therefore performed in any required order.

In step S501, the employment seeker 111 logs into the system 100 via the public station 101. In this instance, the employment seeker 111 may be, for example, a student and the public station 101 may be, for example, a kiosk. In this regard, the employment seeker 111 may be required to supply an identifier, password, and/or code to access the system 100.

In step S502, the employment seeker 111 is presented with one or more video recordings, which include, for example, an introductory video to explain the features and benefits of the system 100, or instructions for operating the public station 101 and/or the recording process. The video recordings may also include, for example, one or more sample videos. The employment seeker 111 may also be presented with pre-recorded recommended outlines including, for example, the ability to play back personalized content utilizing a teleprompter type interface. The user 111 may also be presented with a wizard to help the employment seeker 111 prepare for the recording.

In step S503, the employment seeker 111 initiates a recording. In this instance, the employment seeker 111 may, for example, press the Start button 403 to begin the recording. The recording may include, for example, both audio and visual input. In this regard, it may be recommended that the employment seeker 111 be prepared with a script for recording.

In step S504, the employment seeker 111 pauses and restarts if desired. In this instance, the employment seeker 111 may, for example, press the Pause button 404 to pause the recording. The employment seeker 111 may also, for example, press the Start button 403 to restart the recording. It will be appreciated that the recording may be restarted from the beginning or continue from where it was paused.

In step S505, the employment seeker 111 stops the recording. In this instance, the employment seeker 111 may, for example, press the Stop button 405 to stop the recording. It will be appreciated that the employment seeker 111 may be presented with the opportunity to start and stop the recording as often as desired, to review the recording, and to re-record if desired.

In step S506, a rendering and upload of data occurs from the public station 101 to the data center 106. The rendering may include, for example, a compression of the data. The upload data from the public station 101 to the data center 106 may involve, for example, high speed data communications, such as may be provided, for example, via broad band communications such as those which utilize a T1/T3 connection, OC data formats, and ISDN. The upload may also involve, for example, a dial-up modem connection, wireless network access, WANS, MANS, LANS, cellular networks, etc.

The upload of data may occur, for example, when the employment seeker 111 presses the Done Button 406. Alternatively, the upload of data may occur, for example, when the employment seeker 111 presses a Submit button.

In step S507, the employment seeker 111 is logged out of the system 100. In this regard, the employment seeker 111 may, for example, be automatically logged out of the system 100 upon pressing the Done button 406.

It will be appreciated that the exemplary method 500 may be applicable to an interaction of the employment seeker 111, the private station 102, and an application of the system 100 as well, particularly, if the private station 102 includes audio/video recording capabilities.

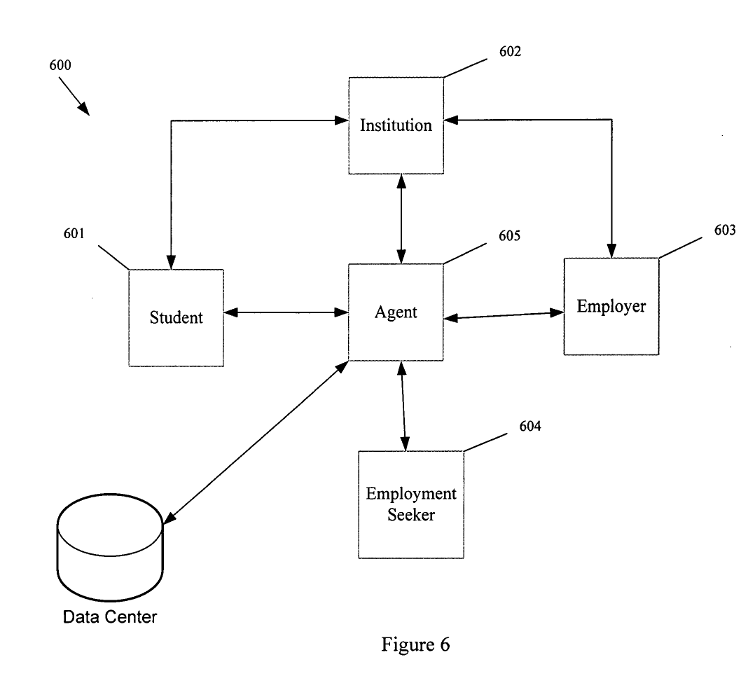

FIG. 6 shows an exemplary partnership arrangement and/or exemplary method 600 to facilitate the exchange of information regarding members of the partnership. The partnership arrangement may include, for example, partnership members 601-604 and an agent 605. The members of the partnership may include, for example, a student 601, an institution 602, an employer 603, and/or an employment seeker 604. The agent 605 may be, for example, a service provider for the system 100. The agent 605 may also be, for example, at least partially computer implemented. In particular, the agent 605 may include, for example, a computer interface such as a Web page. The agent 605 may also include, for example, personnel of an organization. The personnel may include, for example, the administrator 115 of the exemplary system 100 and/or a representative for the exemplary system 100. It will be appreciated that more or fewer partners may be provided.

The information may include, for example, core information and administrative information. The core information may include, for example, a cover letter, a resume, a writing sample, a letter of recommendation, a video, and any other information in a suitably presentable form. The members of the partnership may supply the information, for example. In particular, the information may be supplied, by the student 601, the institution 602, the employer 603, and/or the employment seeker 604. The information may be digitally recorded, stored in a suitable storage medium, and distributed using a computer-implemented system 100.

The exemplary method 600 may involve the agent 605 contacting a prospective institution 602, the institution 602 contacting a prospective employer 603, the agent 605 contacting the prospective employer 603, the institution 602 approaching the agent 605 for a contract of business, the employer 603 approaching the institution 602, the institution 602 in turn contacting the agent 605, the institution 602 contracting with the student 601, and the student 601 contracting directly with the agent 605. Once the agent 605 receives a “buy in” from the institution 602 or any of the above-referred to partnership members, an agreement may be executed to provide digitally recorded data to one or more members of the partnership. The agreement may include, for example, a specific cost to use the system 100. The specific cost may be, for example, a function of the total number of employees of the employer 603.

The exemplary method 600 may also include housing data in a remote location, which may be accessible, for example, via a secured Internet connection. In this regard, the data may be housed, for example, in data center 106 of the exemplary system 100. To access the data, the agent may require basic information from a partnership member, such as an identifier (ID). In this manner, the agent may control the activities of the partnership members as they search, for example, for prospective parties to interact with and exchange information. Through one or more exemplary procedures, defined for example, by the partnership members and/or the agent, information may be maintained in a controlled manner by the partnership members themselves. Initially, the information may be arranged or setup by the in-house personnel or representatives of the agent and subsequent revisions/additions may be provided by the partnership members.

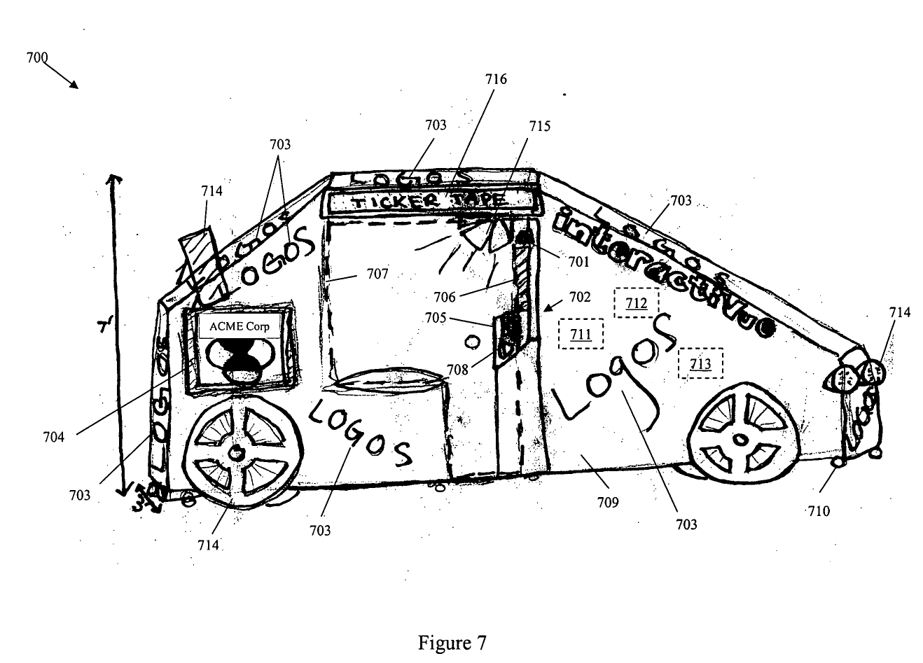

FIG. 7 shows an exemplary arrangement 700 for the public station 101 of FIGS. 1A and 1B. The arrangement 700 includes digital video and audio equipment 701, and a user interface 702 to provide employment seekers, such as students, for example, with an easy to use, sound proof, private and/or comfortable capturing environment. The exterior of the arrangement 700 may display logos 703, including the logos of corporate sponsors, and may include an embedded flat screen 704 for news flashes and advertisements or ticker tape display 716. Inside the arrangement 700, students may sit at a “dummy” computer with a keyboard 705 for login, and access a user interface implemented as flat touch screen monitor 706, which may be used to capture, compress, and upload videos to a server located, for example, in the data center 106. The background 707 behind the user may include a cinema graphic blue/green screen to provide selectable background environments. Control buttons 708 may be provided to trigger a starting, stopping, and re-recording of the capture, or to perform a logout. An upload button may be used to compress and upload the recording to the server, which may store the recording in an appropriate user account. The arrangement 700 also includes a housing 709 that may roll on wheels 710 to provide added mobility. The housing 709 may be configured to represent, for example, a motor vehicle with exemplary motif features 714. It will be appreciated that the housing 709 may be configured to represent other entities as well.

The arrangement 700 may also include a control arrangement 711, a wireless interface 712, and a wired interface 713.

According to an exemplary embodiment and/or an exemplary method of the present invention, stations of the exemplary system 100 of FIGS. 1A and 1B, such as the public station 101 or the private station 102, may provide live interviewing between employers and employment seekers. For example, a live interview may be provided between and student 111 and a recruiter 114 or other representative of an employer. In this instance, the recruiter 114 or other representative of the employer may require a suitably equipped station as well. When connected, the student 111 and recruiter 114 may view and hear each other in a live manner via a monitor and speakers, which are provided. In this regard, an interviewing environment simulating the physical presence of the interview participants may be provided.

The public station 101 may also have the ability to record video segments of the recruiter 114 asking interview questions. Each segment may include, for example, one question. The video may then be uploaded to the corporation's web space to be posted. Students may visit the public station 101 and perform a pre-recorded/live interview. Each video question segment may be played in order, one at a time for the student 111, visually and orally. Recording of the live student responses may be captured. When the student 111 is finished, the video may be compressed and uploaded to the corporation webspace and an alert may be provided to the recruiter 114 indicating an update of a new interview to be watched at a time of their choosing, for example. Hence, an exemplary embodiment and/or exemplary method of present invention may provide to the recruiter 114 and student 111 a more convenient and therefore a more timely and valuable recruiting experience, since, for example, a company or employer may interview multiple students at once without being physically present (thereby providing a time savings which may be used, for example, to performing other tasks). This may also be helpful for “coast-to-coast” connections involving different time zones.

As digital recording equipment becomes more widely affordable for consumers, suitably equipped private stations, such as a personal computer, may be used to record videos as well.

According to an exemplary embodiment of the present invention, the public and private stations may be provided as one station made available in a public, private, or semi-private manner as desired.

According to an exemplary embodiment of the present invention, after viewing a recorded video and/or portfolio of an employment seeker 111, the viewer (e.g., the recruiter 114) may be presented with a popup window with a series of short questions and a comment box. In particular, the viewer may be prompted, for example, to enter a ranking based on a scale from 1 to 5 in terms of how well the employment seeker performed (e.g., Does the employment seeker speak well?). In this regard, the questions may be reflective of what students would want to know to better represent themselves. Hence, the comments may serve as feedback for the employment seeker.

According to an exemplary embodiment of the present invention, employment seekers may be provided with a digital report card of comments as well as a report of how they compare to other employment seekers. A counter may also be provided indicating how many recruiters viewed their information. This may provide an incentive for employment seekers to update the information.

According to an exemplary embodiment of the present invention, an average of all recruiter rankings may be provided, in which a score for the employment seeker may serve as a search filter. Recruiters may further search for employment seekers by filtering out only those employment seekers whose ranking exceeds a particular value. Hence, recruiters may consider the perceptions of other recruiters as well.

Moreover, unlike other conventional interviews, in which the employment seeker may have little or no follow-up, the feedback provided by an exemplary embodiment of the present invention may enable the employment seeker to improve or adjust with future interviews. Consequently, employment seekers may become better candidates for employment.

According to an exemplary embodiment of the present invention, the employment seeker may be provided with a personality test, in which results from the test may be provided to recruiters so they may further tailor their search. Accordingly, personality or other type search filters should broaden the criteria for acceptance amongst recruiters and help students that may not excel in standardized tests as represented, for example, by a single grade point average, but may provide additional information in terms of personality, experience and interview skills, which may be important to a recruiter.

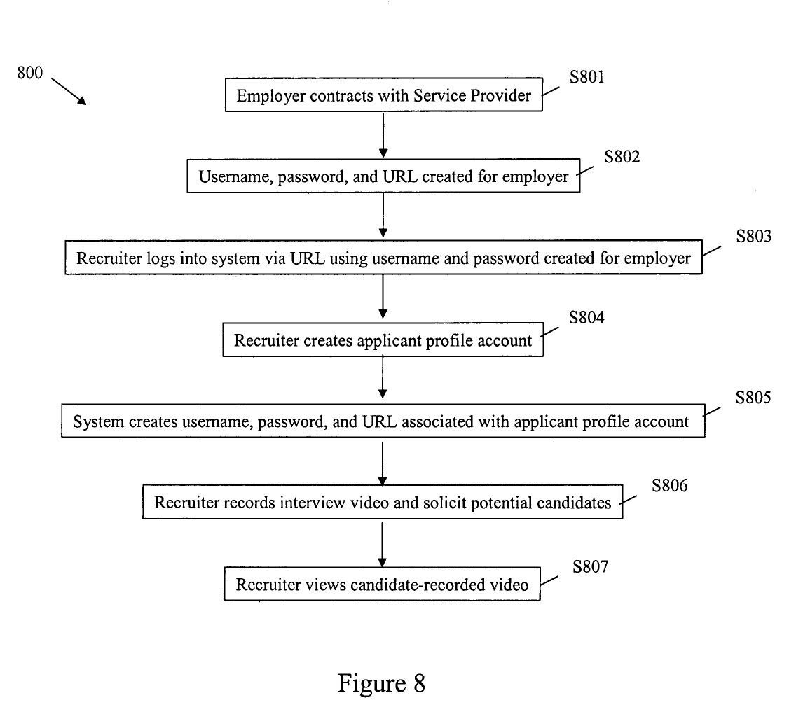

FIG. 8 shows an exemplary method 800 for exchanging information between and employer and an employment seeker, from the perspective of the employer and using, for example, the exemplary system 100 of FIGS. 1A and 1B. In step S801 the employer or representative of the employer 114 contracts with the service provider or administrator 115 of the exemplary system 100 for a service subscription. In this regard, the employer or representative 114 may be, for example, a corporate human resource group, an executive recruitment firm, a vocational school, an outplacement firm, a university, or a career center. The service provider 115 may be, for example, a provider of the system, including the data center 106. The service subscription may be, for example, a monthly subscription service.

In step S802, the service provider 115 configures the system 100 to permit access to system 100 by the employer or representative 114. In this regard, the service provider 115 may provide to the employer 115 a username, password and predefined website address (e.g., URL) to gain access into the system 100.

In step S803, a recruiter or other representative of the employer 114 logs into system 100 via the predefined website address (e.g., URL) using the previously supplied username and password.

In step S804, upon successful login, the recruiter 114 accesses an account management interface and creates an applicant profile. In this regard, the applicant profile may be created, for example, by selecting appropriate option(s) and/or completing an online form. In particular, the recruiter 114 may enter the applicant profile information into a predefined account and designate a time limit associated with the account. The process of creating an applicant profile account may also be referred to as applicant profile account registration.

In step S805, upon successful creation of an applicant profile account, the system 100 creates a user name, password and URL associated with the applicant profile account.

In step S806, the recruiter 114 solicits or requests potential candidates 111 (e.g., applicant, student, or other employment seeker) to record one or more video profiles of themselves. For example, the recruiter 114 may solicit a potential candidate 111 by sending an email to the potential candidate specifying the username, password, and URL associated with the applicant profile account. The recruiter 114 may be provided with an option to create a custom video interview, with questions prepared by the recruiter 114 to simulate a live interviewing session. For example, if the candidate 111 is to be provided with an opportunity to enter teleprompter speech, the recruiter 114 may be provided with the option of recording the verbal communications associated with the teleprompter. The recruiter 114 may also be provided with an option to review and/or re-record the video interview, or an option to determine whether the candidate 111 is to have access to review their video and/or re-record the video.

In step S807, upon completion of a video recording by the potential candidate 111, the recruiter 114 accesses the candidate-recorded video at any time (e.g., instantly) via their account manager screen, and may circulate the candidate-record video internally or externally via email and the World Wide Web. For example, the recruiter 114 may retrieve the video recording by logging onto the predefined website address and access the candidate's account. The recruiter 114 may then use a URL associated with the candidate video to cut and paste information into the candidate's resume and forward the video via email to another reviewer or employer.

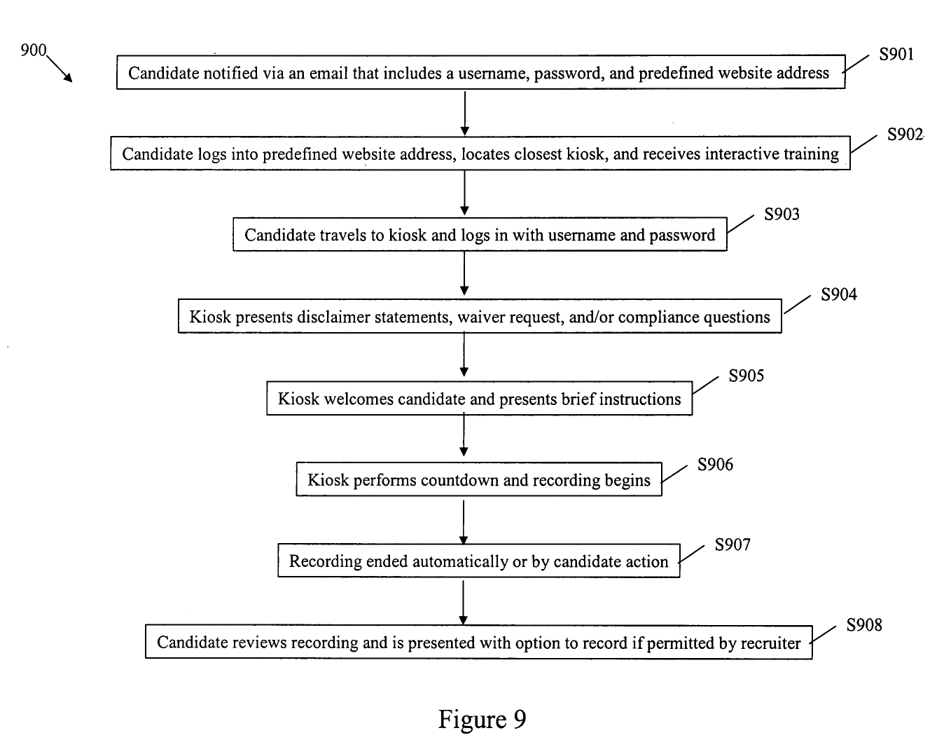

FIG. 9 shows an exemplary method 900 for exchanging information between an employer and an employment seeker, from the perspective of the employment seeker, using, for example, the exemplary system 100 of FIGS. 1A and 1B. In step S901, a potential candidate 111 (e.g., applicant, student, or other employment seeker) receives notification that they have been requested to record a video. In this regard, the potential candidate 111 may receive, for example, an email, which includes a user name, password, predefined website address (e.g., URL) and/or further instructions for the creation of their video.

In step S902, the candidate 111 logs into the system 100 via the predefined website address (e.g., URL) to find the closest kiosk 101 (or other access terminal of the system). The closest kiosk 101 may be located, for example, at a workplace office, university campus, corporate office, a career center, or any other suitable location. In this regard, the potential candidate 111 may be provided with driving directions to the closest kiosk 101, and an option to schedule or reserve a recording time. The candidate 111 may also be provided with an interactive training session via the predefined website address, which may include a simulated recording experience to prepare the candidate for recording a video at the kiosk 101.

In step S903, the candidate 111 travels to the kiosk location, where the candidate 111 may be greeted, for example, by an assistant who guides the candidate 111 to the kiosk terminal 101. Upon accessing the kiosk terminal 101, the candidate 111 is presented with an interactive interface (e.g., touch-screen interface), which prompts the candidate 111 to enter a username and password. In this regard, the candidate 111 is required to enter the username and password supplied in step S901.

In step S904, upon supplying the proper username and password, the candidate 111 may be presented with certain disclaimer statements, waiver requests and/or regulatory compliance questions. For example, the kiosk interface may present the candidate 111 with a screen including an Equal Employment Opportunity Commission (EEOC) disclaimer statement asking for the candidate 111 to voluntary accept or decline (e.g., via an accept or decline button) certain conditions of use of the system 100 and/or the video/screening process.

In step S905, the kiosk interface may then welcome the candidate 111 and present a brief instruction page to ensure, for example, that the candidate 111 has certain controls in hand (e.g., candidate 111 has the stop button in hand to end the video) and has assumed proper body position. The candidate 111 may then indicate via the proper kiosk interface control (e.g., a “next” button) to initiate the recording process.

In step S906, the kiosk 101 performs a countdown and the recording process begins. If the candidate 111 has prepared a teleprompter communication, it is shown on the kiosk screen to assist the candidate 111 during the recording process. If the recruiter 114 has selected a question and answer type screening the candidate 111 is presented with each question and is prompted to provide a video answer.

In step S907, the recording is terminated when the candidate 111 provides responses to all questions or the candidate 111 indicates that the recording should end (e.g., pressing the “end” button).

In step S908, upon completion of the recording, if the recruiter 114 permitted the candidate 111 to review or re-record their video, the choice is given to the candidate 111 to do so at this time.

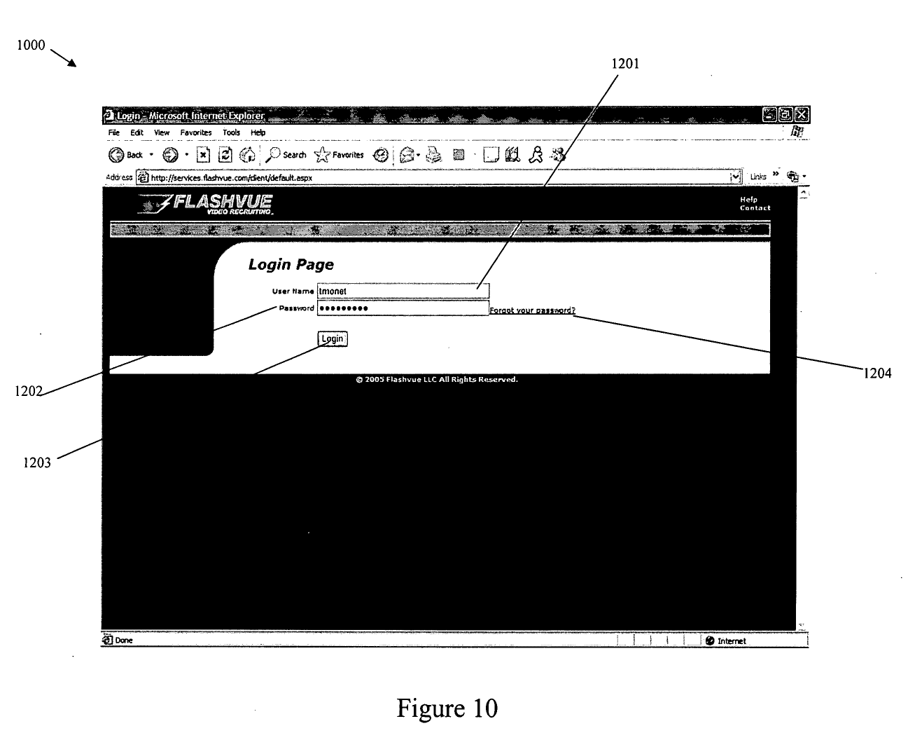

FIG. 10 shows an exemplary login screen 1000 to enter username and password information required to access the system. In this regard, the exemplary login screen 1000 may be presented to a user (e.g., an employer or recruiter of the employer) via a predefined website address (e.g, URL). The exemplary login screen 1000 includes a username entry field 1001, a password entry field 1002, a login button 1003, and a “Forgot your password?” link 1004.

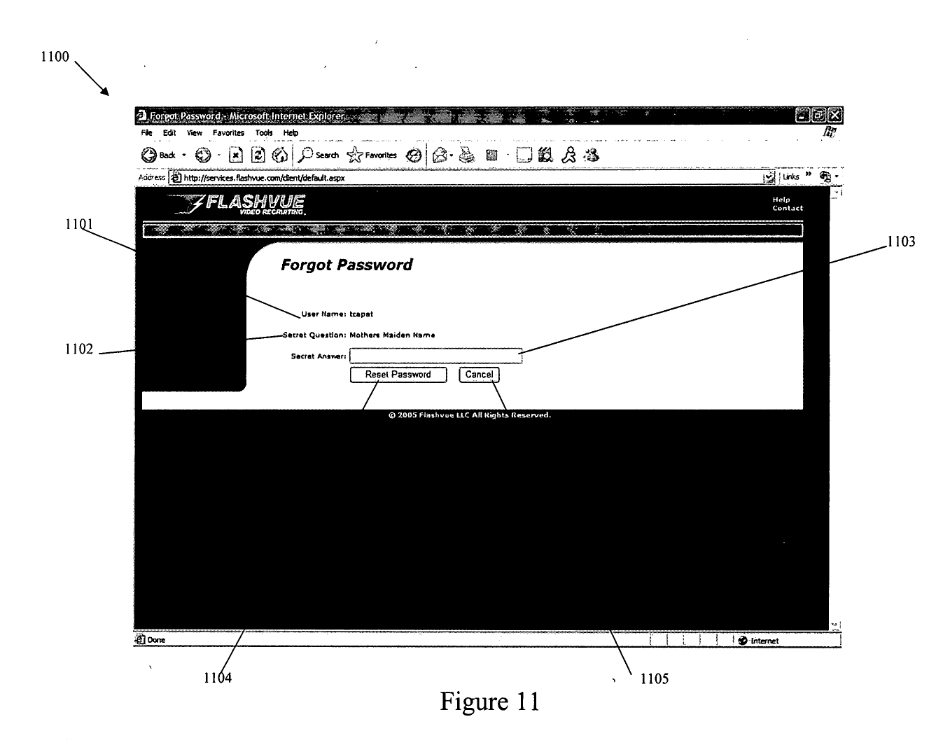

FIG. 11 shows an exemplary forgot password screen 1100, which is presented upon access the “Forgot your password?” link 1004 of the exemplary login screen 1000 of FIG. 10. The exemplary forgot password screen 1100 includes a user name display field 1101, a secret question display field 1102, a secret answer response field 1103, a reset password button 1104, and a cancel button 1105.

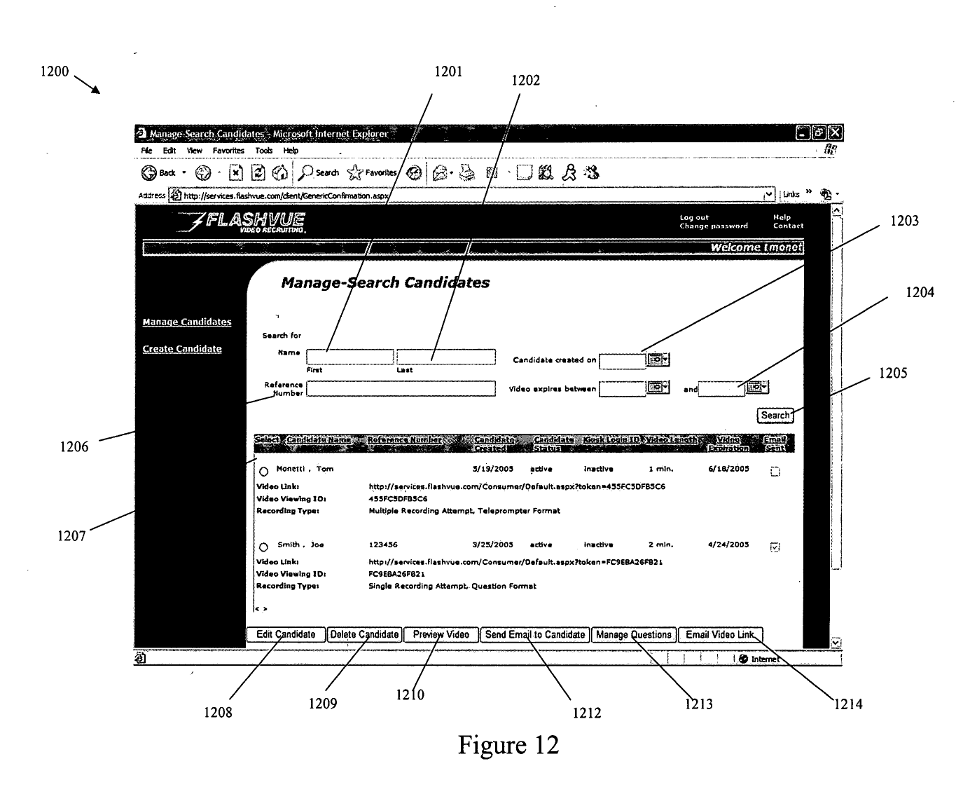

FIG. 12 shows an exemplary manage-search candidates screen 1200 to manage and search candidate information. The exemplary manage-search candidates screen 1200 includes a first name entry field 1201, a last name entry field 1202, a reference number entry field 1203, a candidate creation date entry field and drop down menu 1204, a video expiration date entry field and drop down menu 1205, a search button 1206, a search results field 1207, an edit candidate button 1208, a delete candidate button 1209, a preview video button 1210, a send email to candidate button 1211, a manage questions button 1212, and an email video link button 1213. The search results field 1207 displays information such as, for example, the candidate name, a reference number, a candidate creation date, a candidate status, a kiosk login identifier, a video length, a video expiration date, and an indication if an email was sent. The search results field 1206 may also display for each listed candidate a video link, a video viewing identifier, and an indication of the type of recording (e.g., Question Format, Teleprompter Format, and Single or Multiple Recording Attempt).

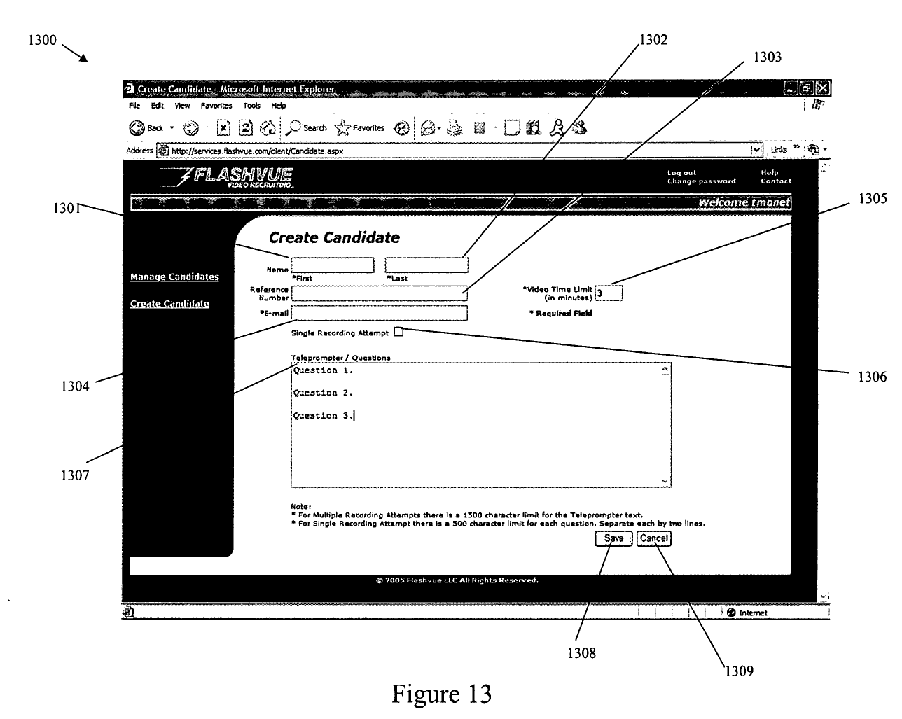

FIG. 13 shows an exemplary create candidate screen 1300 to create a candidate profile. The exemplary create candidate screen 1300 includes a first name entry field 1301, a last name entry field 1302, a reference number entry field 1303, an email entry field 1304, a video time limit entry field 1305, a single recording attempt indication field 1306, a teleprompter/questions entry field 1307, a save button 1308, and a cancel button 1309.

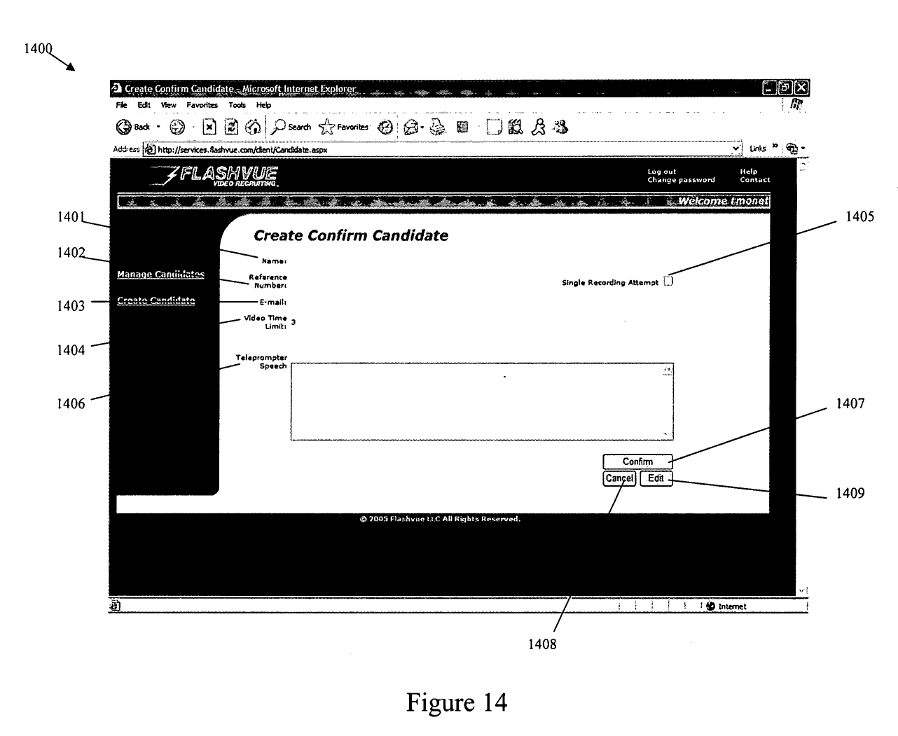

FIG. 14 shows an exemplary create confirm candidate screen 1400 to confirm the information entered in the exemplary create candidate screen 1300 of FIG. 13. The exemplary create confirm candidate screen 1400 a name display field 1401, a reference number display field 1402, an email display field 1403, a video time limit display field 1404, a single record attempt indication display field 1405, a teleprompter speech display field 1406, a confirm button 1407, a cancel button 1408, and an edit button 1409.

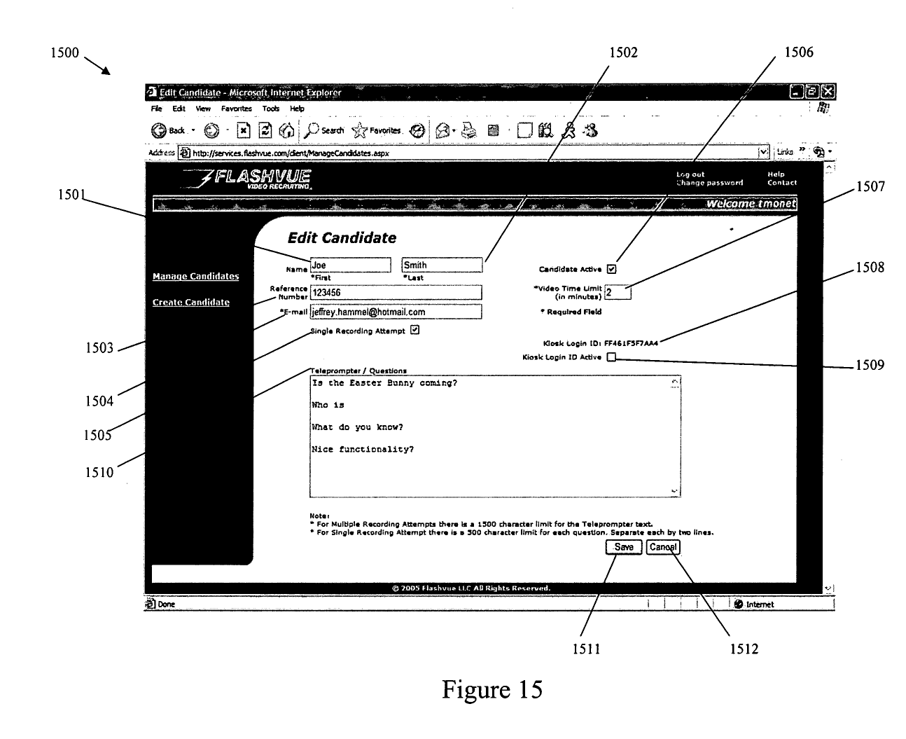

FIG. 15 shows an exemplary edit candidate screen 1500 to edit a candidate profile. The exemplary edit candidate screen 1500 includes a first name entry field 1501, a last name entry field 1502, a reference number entry field 1503, an email address entry field 1504, a candidate active indication entry field 1505, a video time limit entry field 1506, a single recording attempt indication entry field 1507, a kiosk login identifier display field 1508, a kiosk login active indication entry field 1509, a teleprompter/questions entry field 1510, a save button 1511, and a cancel button 1512.

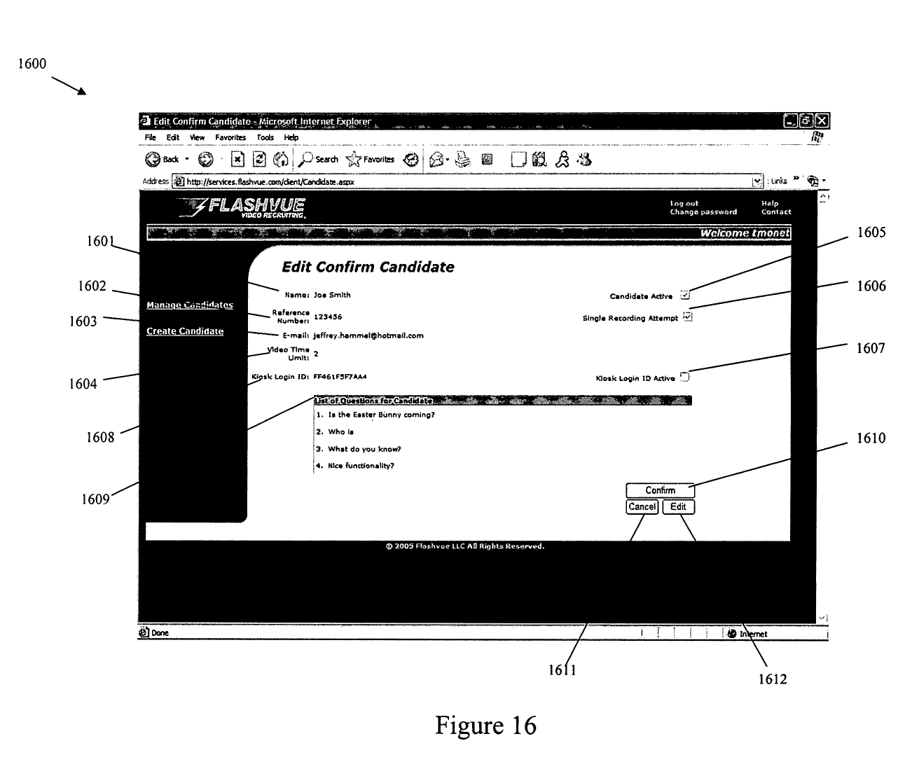

FIG. 16 shows an exemplary edit confirm candidate screen 1600 to confirm information entered in the exemplary edit candidate screen 1500 of FIG. 15. The exemplary edit confirm candidate screen 1600 includes a name display field 1601, a reference number display field 1602, an email address display field 1603, a video time limit display field 1604, a candidate active indication display field 1605, a single recording attempt indication display field 1606, a kiosk login identifier display field 1607, a kiosk login active indication display field 1608, a list of questions for candidate display field 1609, a confirm button 1610, a cancel button 1611, and an edit button 1612.

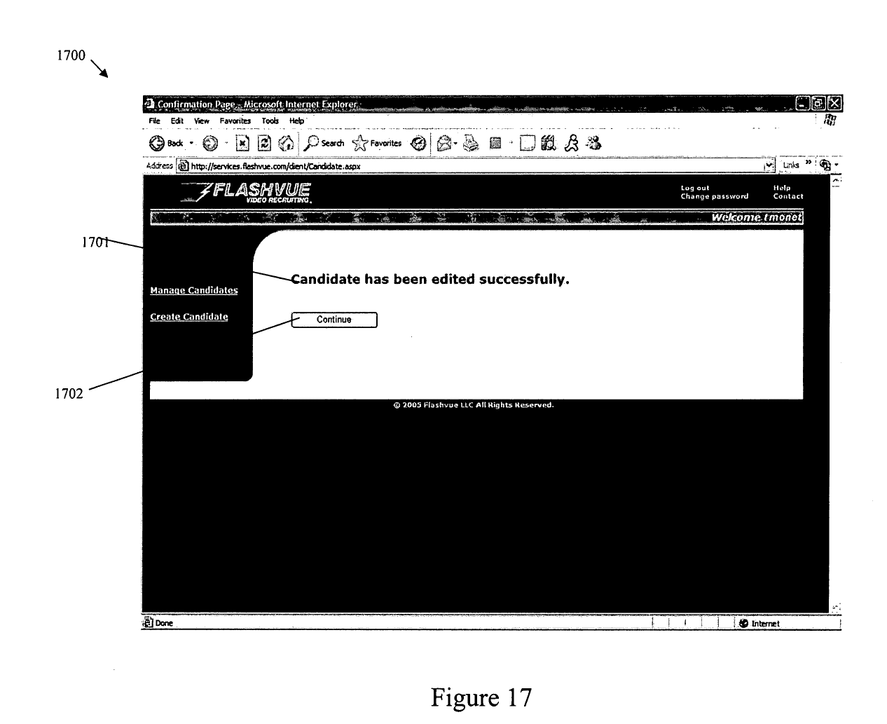

FIG. 17 shows an exemplary candidate edit successful screen 1700 to indicate a successful edit of candidate profile information. The exemplary candidate edit successful screen 1700 includes an indication of success 1701 and a continue button 1702.

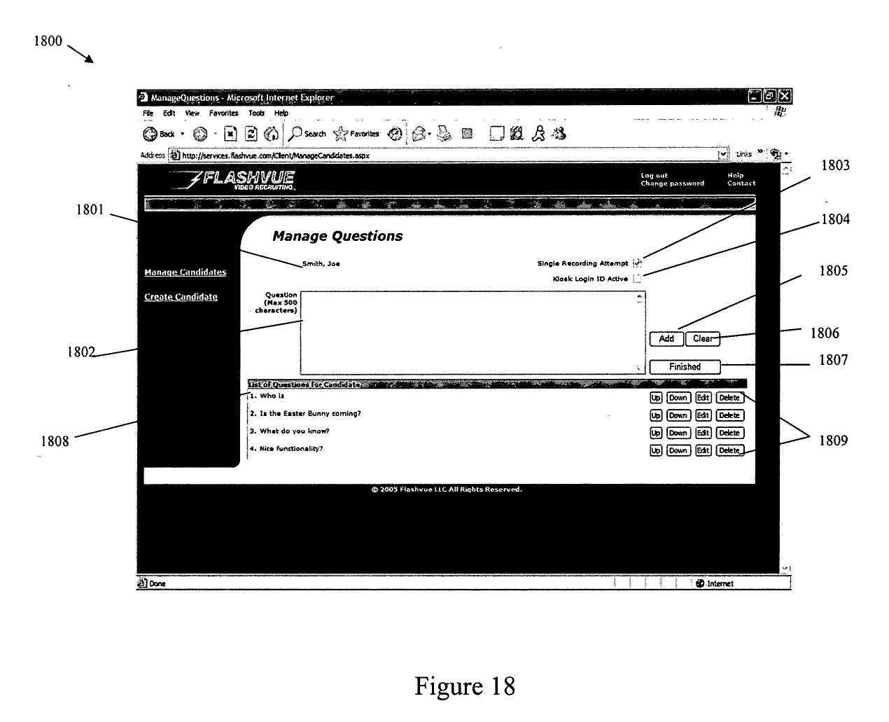

FIG. 18 shows an exemplary manage questions screen 1800 to enter and/or rearrange the order of questions presented to the candidate. The exemplary manage questions screen 1800 includes a candidate name display 1801, a question entry field 1802, a single recording attempt indication entry field 1803, a kiosk login identifier 1804, an add button 1805, a clear button 1806, a finished button 1807, a list of questions 1808, and up/down/edit/delete buttons 1809 for each listed question.

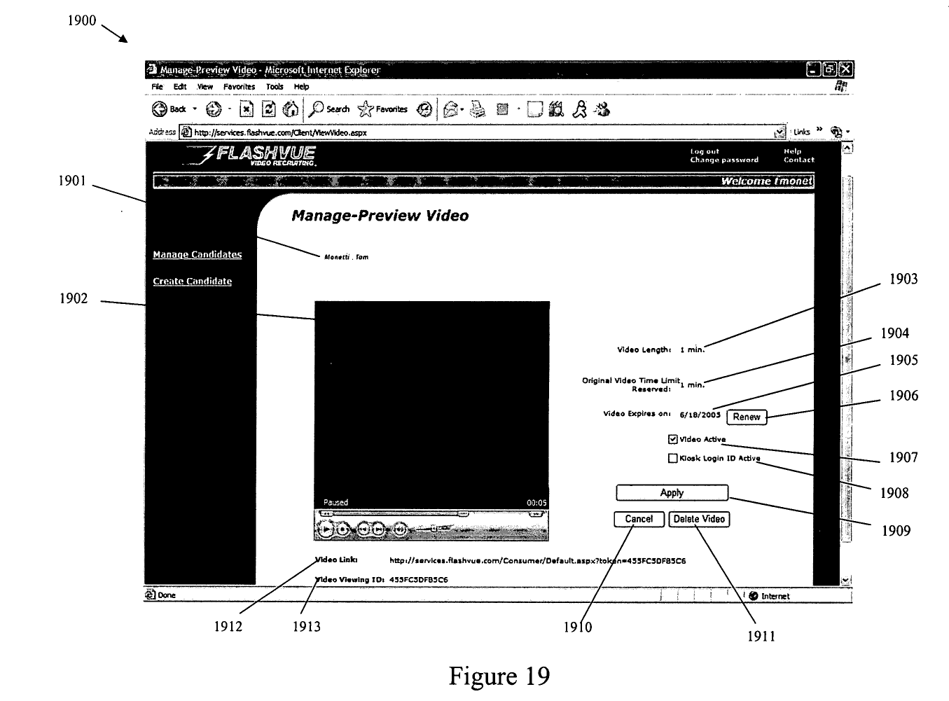

FIG. 19 shows an exemplary manage preview video screen 1900 to manage and/or preview of video. The exemplary manage preview video screen 1900 includes a candidate name display field 1901, a video display field 1902, a video length indication field 1903, an original video time limit indication field 1904, a video expiration date display field 1905, a renew button 1906. a video active indication entry field 1907, a kiosk login identifier action indication entry field 1908, an apply button 1909, a cancel button 1910, a delete video button 1911, a video link indication display field 1912, and a video viewing identifier display field 1913.

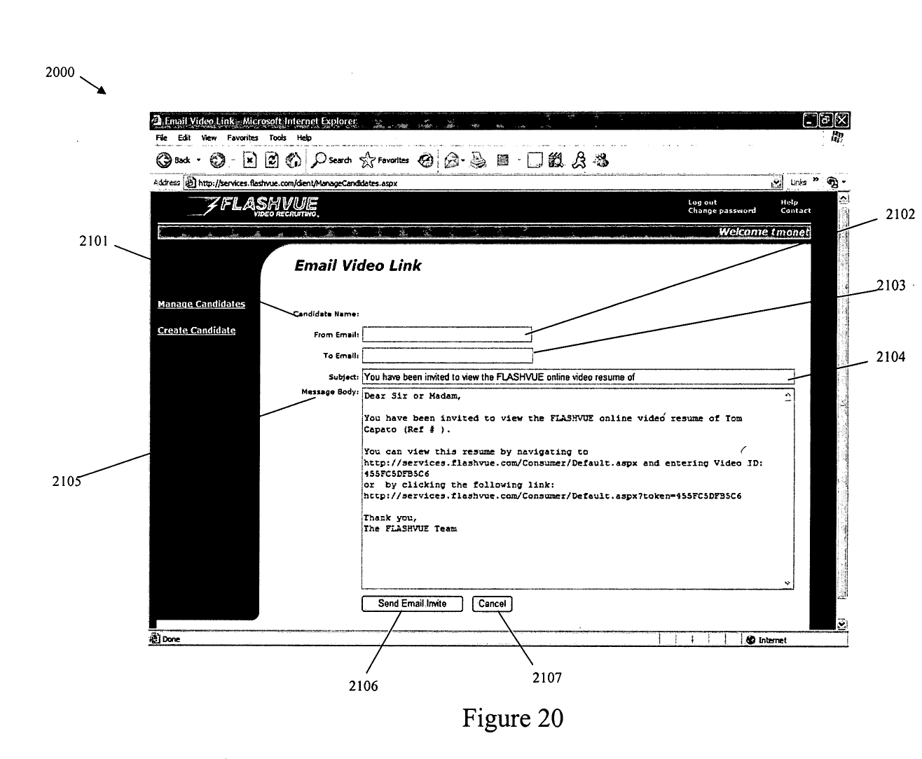

FIG. 20 shows an exemplary email video link screen 2000 to send create and send an email invitation. The exemplary email video link screen 2000 includes a candidate name display field 2001, a “from” email address entry field 2002, a “to’ email address entry field 2003, a subject entry field 2004, a message body entry field 2005, a send email invite button 2006, and a cancel button 2007.

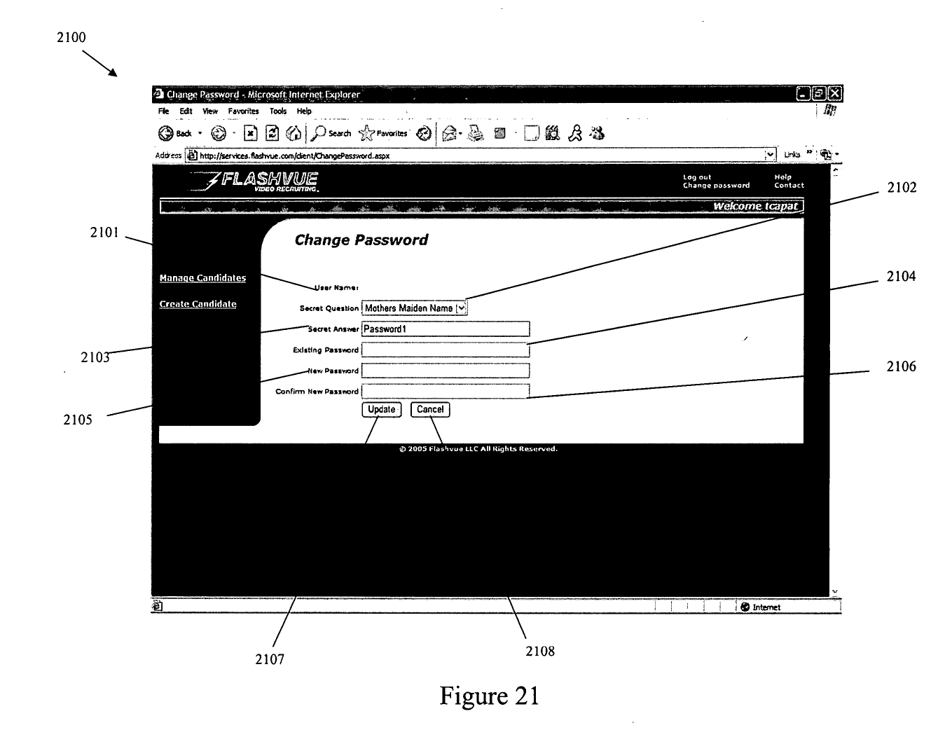

FIG. 21 shows an exemplary change password screen 2100 to change a password associated with a particular user. The exemplary change password screen 2100 includes a user name display field 2101, a secret question drop down menu 2102, a secret answer entry field 2103, a existing password entry field 2104, a new password entry field 2105, a confirm new password entry field 2106, an update button 2107, and a cancel button 2108.

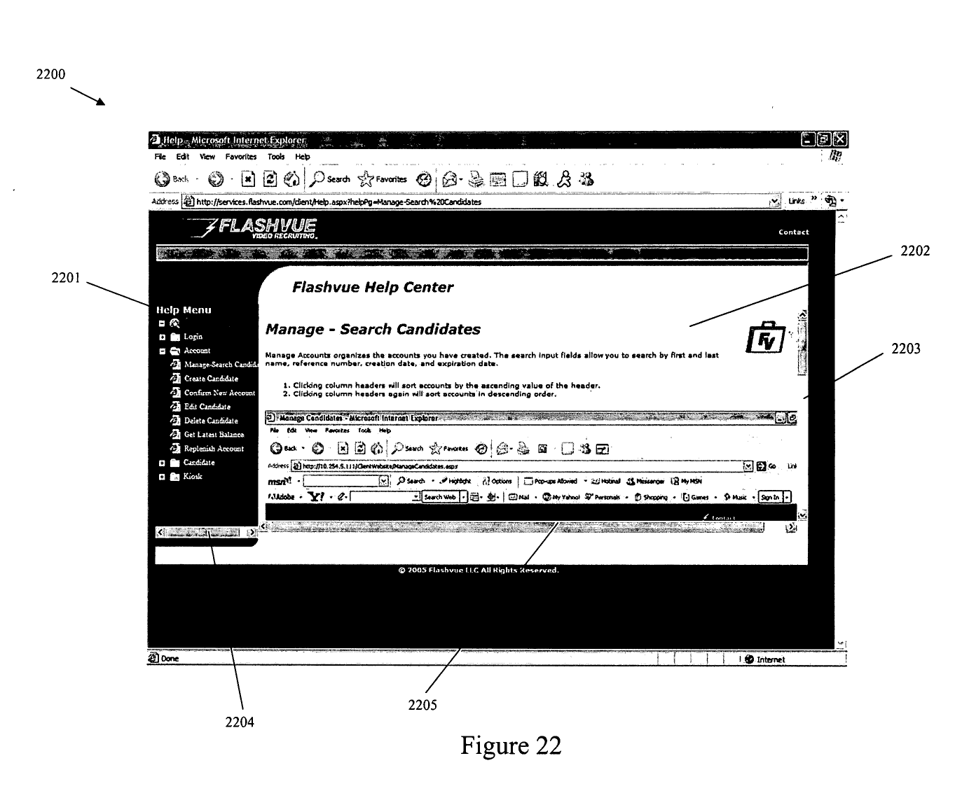

FIG. 22 shows an exemplary help screen 2200 to provide on-line assistance. The exemplary help screen 2200 includes an expandable/contractable table on contents field 2201, an information display field 2202, a vertical scroll bar 2203, and a first horizontal scroll bar 2204, and second horizontal scroll bar 2205.

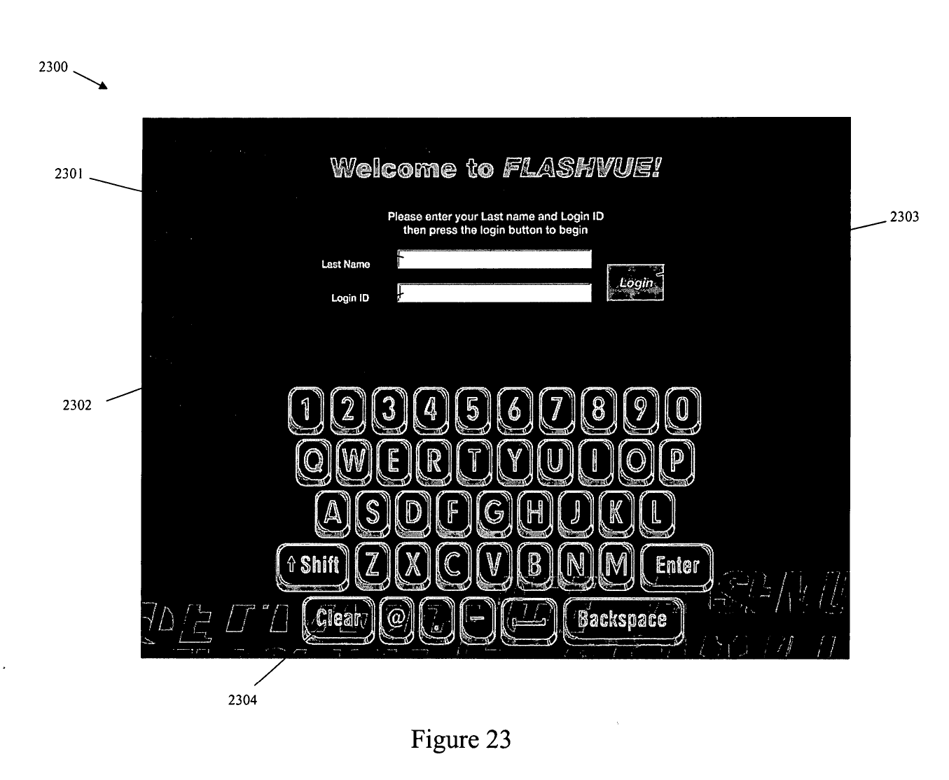

FIG. 23 shows an exemplary login screen 2300 to access a kiosk station for purpose, for example, of recording a video by an employment seeker. In this regard, the exemplary login screen 2300 may be, for example, the first screen displayed on the kiosk station. The exemplary login screen 2300 includes a last name entry field 2301, a first name entry field 2302, a login button 2303, and touch-screen keyboard entry field 2304.

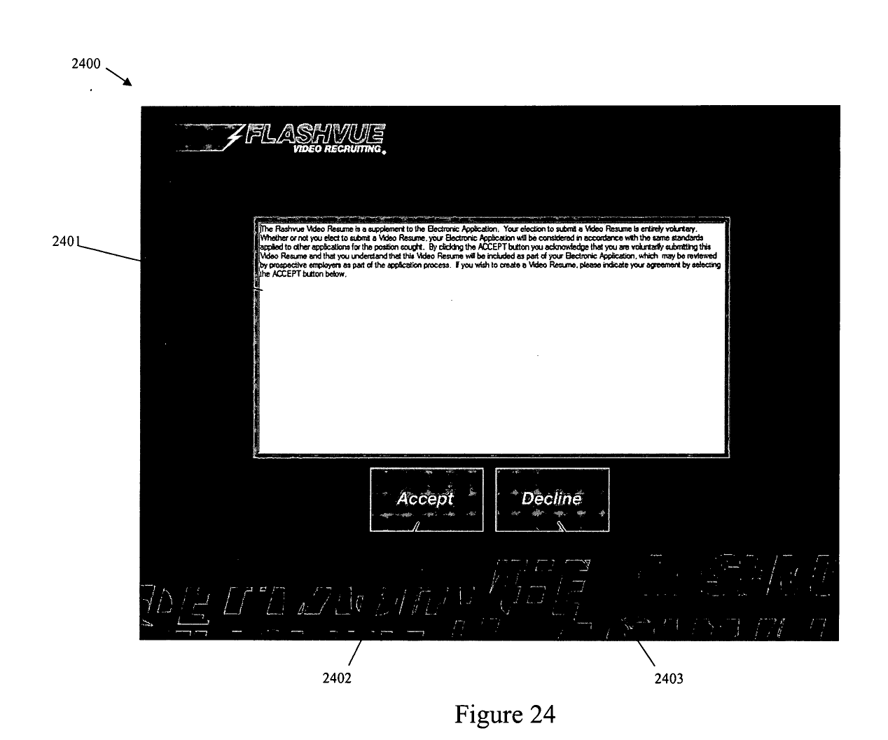

FIG. 24 shows an exemplary disclaimer/waiver screen 2400 to display disclaimer and/or waiver information, and to receive an accept or decline indication from the user. The exemplary disclaimer screen 2400 includes a disclaimer/waiver display field 2401, an accept button 2402, and a decline button 2403.

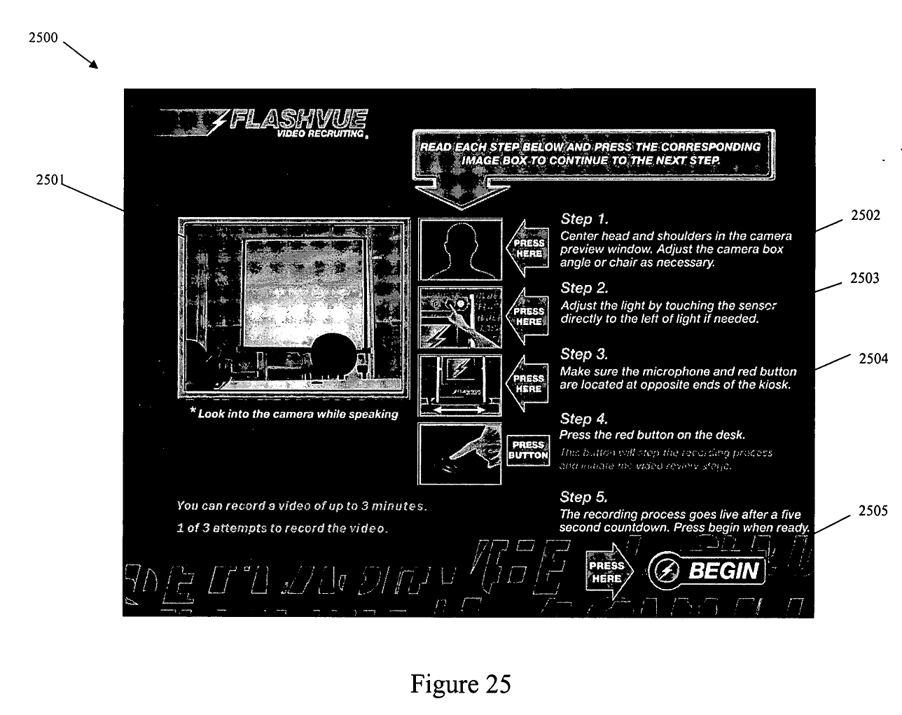

FIG. 25 shows an exemplary prerecording instruction and setup screen 2500 to instruct the user regarding the operation of the kiosk station, including adjustments prior to commencement of recording. The exemplary prerecording instruction and setup screen 2500 includes, a camera preview window 2501, a camera orientation adjustment instruction step entry field 2502, a light adjustment instruction step entry field 2503, a microphone adjustment instruction step entry field 2504, a stop button instruction step entry field 2505, and a begin recording button 2506.

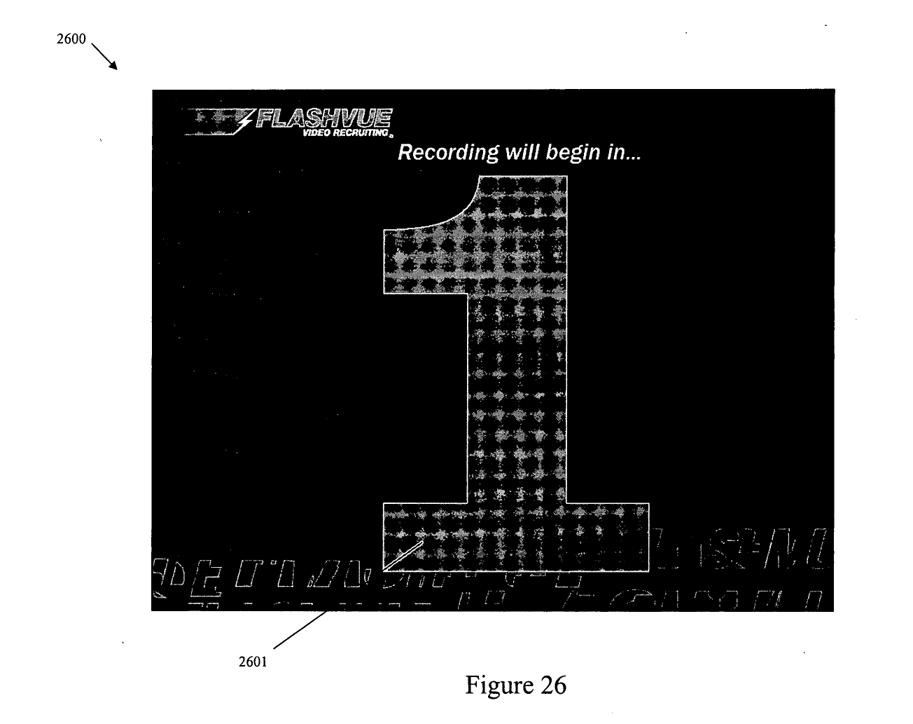

FIG. 26 shows an exemplary countdown screen 2600 to provide a countdown display prior to the start of the recording process. The exemplary countdown screen 2600 includes a countdown number display field 2601, which indicates, for example, the time remaining prior to the start of the recording process. In this regard, the countdown number display field 2601 may display, for example, a sequence of “5”, “4”, “3”, “2”, “1” to indicate that the number of seconds remaining before the recording process begins.

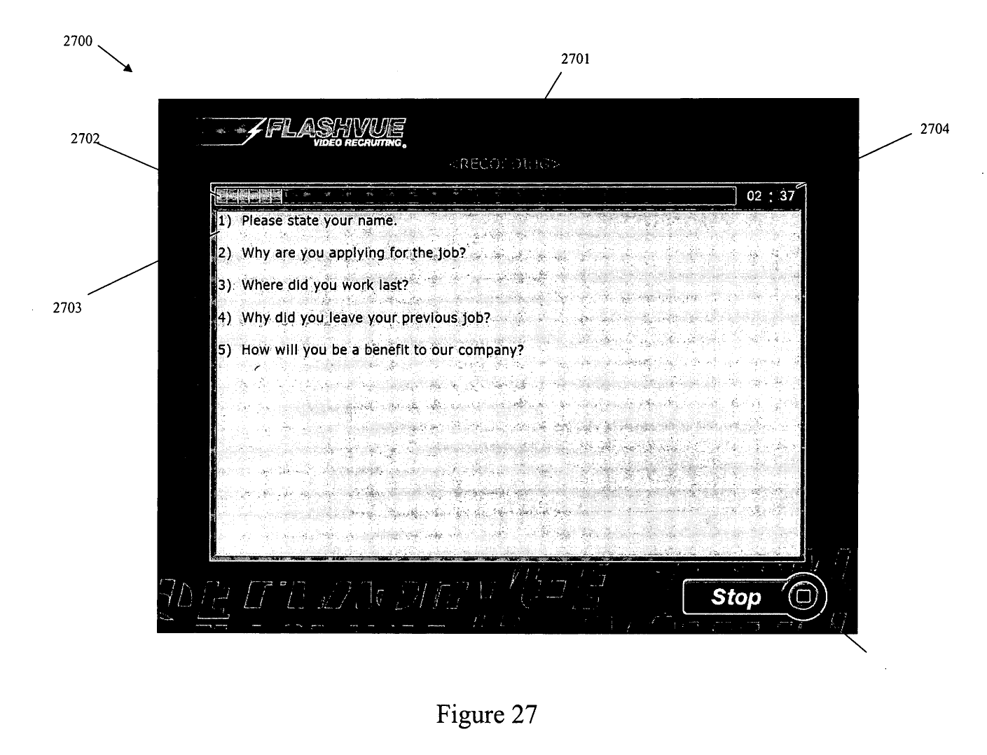

FIG. 27 shows an exemplary teleprompter/question presentation screen 2700 to display, for example, a list of questions intended to solicit specific responses from the user. The exemplary teleprompter/question presentation screen 2700 includes a teleprompter/questions list display field 2701, a recording-in-progress display field 2702, a progress indication status bar 2703, a time remaining indication field 2704, and a stop button 2705.

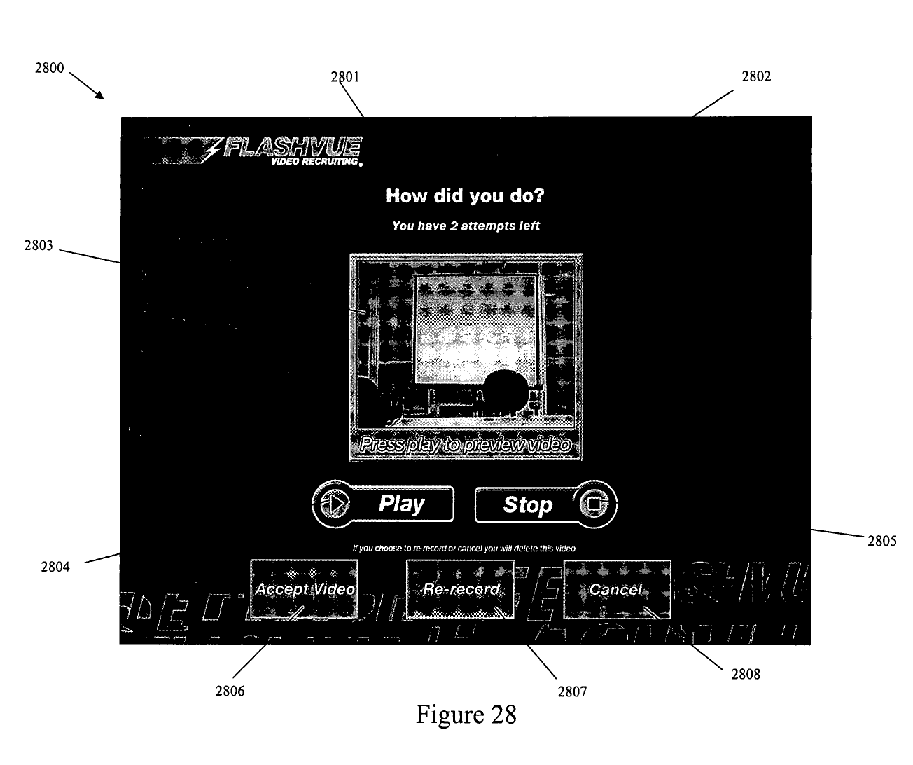

FIG. 28 shows an exemplary post recording screen 2800 to optionally review, accept, re-record, or cancel a recorded video. The exemplary post recording screen 2800 includes a greeting display field 2801, an indication 2802 of the number of available recording attempts left, a video display window 2803, a play button 2804, a stop button 2805, an accept video button 2806, a re-record button 2807, and a cancel button 2808.

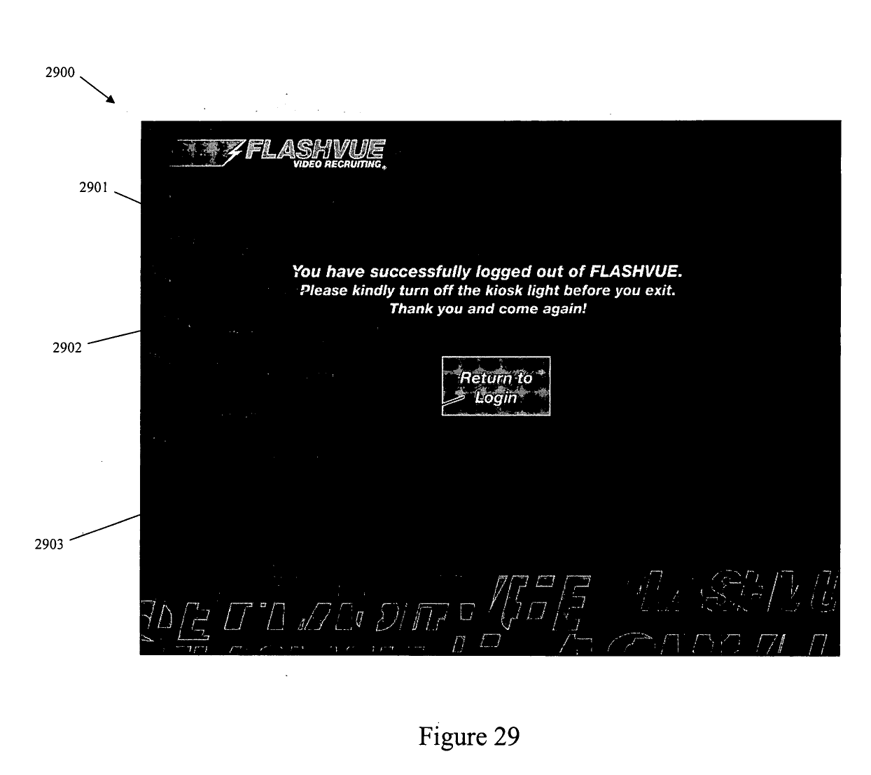

FIG. 29 shows an exemplary logout screen 2900 to provide a proper notice to the user that the kiosk station session has ended. The exemplary logout screen 2900 includes an indication 2901 of successful logout from the system and an instructions 2902 regarding, for example, the preferred logout/shutdown conditions of certain aspects of the kiosk station (e.g., lights turned off).

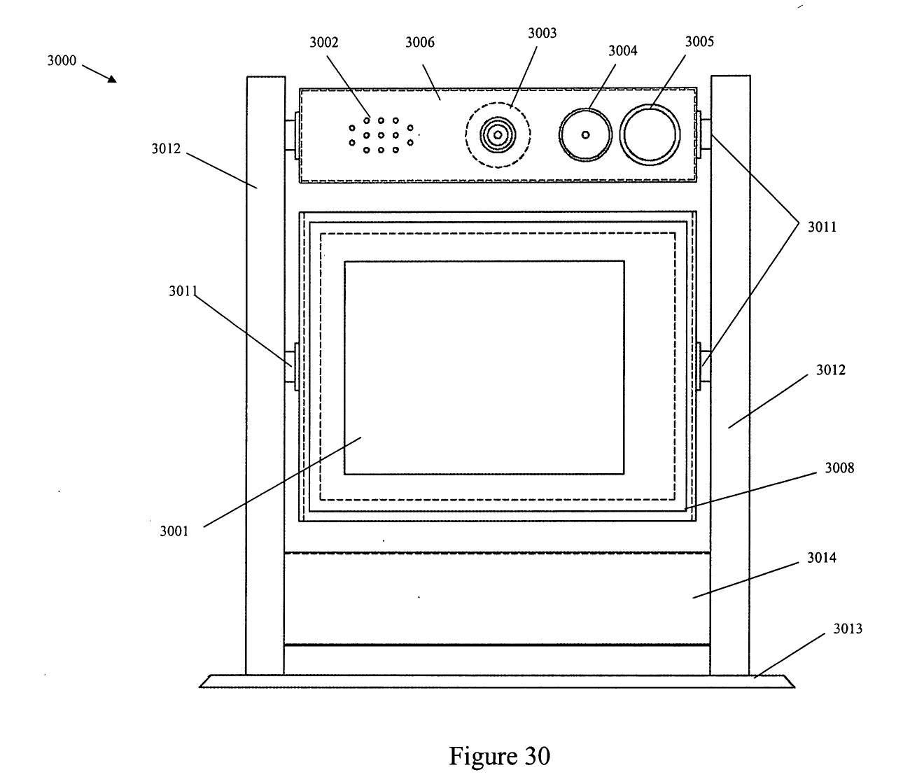

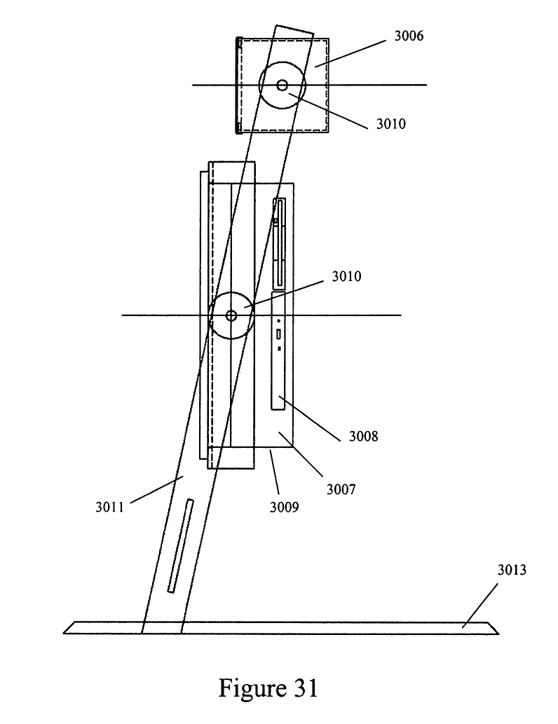

FIGS. 30 and 31 shows a schematic illustration in front and side view of an exemplary kiosk station 3000, which includes a touch screen display 3001, speaker 3002, digital camera 3003, light intensity touch sensor 3004, halogen light 3005, casing 3006, pc panel 3007, pc panel mount 3008 for swivel, CD drive 3009, input/output and power connections 3010, swivel connectors 3011, aluminum tubing supports 3012, aluminum base 3013, and logo plate 3014.

The exemplary kiosk station 3000 may be configured as a one-piece desktop unit to record a audiovisual data in a self tutorial manner, so that employment seekers may record themselves without a requiring a second party (e.g., camera person) to assist them. In this regard, the kiosk station 3000 may be adjusted to accommodate employment seekers of essentially all sizes. A next question/stop button may be used by the employment seeker to command the recording process without being seen.

The exemplary kiosk station 3000 may also display a presentation prepared, for example, by the employer, which may facilitate the recording of an audiovisual response by the employment seeker. The exemplary kiosk station 3000 may compress the recorded audiovisual response and upload it to a data center and/or other systems servers, where the audiovisual response may undergo decompression and/or further processing. For example, a speech-to-text software application may convert a speech component of the audiovisual response into a text file (e.g., transcript file), which may be collected with other speech-to-text converted text files derived from other audiovisual responses from other employment seekers, thereby enabling an account management tool to perform search queries on a particular response that may have been provided by the employment seeker(s).

In the preceding specification, the present invention has been described with reference to specific exemplary embodiments and/or exemplary methods. It will, however, be evident that various modifications and changes may be made thereunto without departing from the broader spirit and scope of the present invention. For example, the exemplary embodiments and/or exemplary methods provide herein may be suitable for not only employment seekers but also seekers of other types of positions or membership, including, for example, a student seeking acceptance to a university or a person seeking membership in an organization. The specification and drawings are accordingly to be regarded in an illustrative rather than restrictive sense.

What is claimed is:

1. A method for exchanging information between an employer and an employment seeker, the method comprising:
receiving multimedia-formatted information from the employment seeker via a station;
uploading the multimedia-formatted information from the station to a data center via a first communications network; and
providing to the employer access to the multimedia-formatted information via a second communications network.

2. The method of claim 1, wherein the multimedia-formatted information includes an audiovisual recording of the employment seeker.

3. The method of claim 1, wherein the multimedia-formatted information is recorded at the station.

4. The method of claim 1, wherein the multimedia-formatted information includes streaming media.

5. The method of claim 1, wherein access to the multimedia-formatted information is provided via a web link.

6. The method of claim 1, further comprising:
receiving applicant profile account information from the employer;
creating a presentation based on the applicant profile account information received from the employer;
presenting the presentation to the employment seeker via the station; and
recording an audiovisual response from the employer seeker.

7. The method of claim 6, wherein the presentation includes a teleprompter.

8. The method of claim 7, wherein the teleprompter includes a question intended to solicit the audiovisual response from the employment seeker.

9. The method of claim 6, further comprising:
converting a speech component of the audiovisual response into text.

10. The method of claim 6, further comprising:
providing to the employer a predefined website address to enter the applicant account profile information.

11. The method of claim 6, further comprising:
communicating to the employment seeker a password to access the presentation via the station.

12. The method of claim 6, further comprising:
communicating to the employment seeker a predefined website address to at least one of locate the station, reserve a time to use the station, and receive instructions regarding an operation of the station.

13. The method of claim 12, wherein the predefined website address is communicated electronically.

14. A system for exchanging information between an employer and an employment seeker, comprising:
a data center to store multimedia-formatted information; and
a station interconnected with the data center via a communications network to receive the multimedia-formatted information from the employment seeker and to upload the multimedia-formatted information to the data center,
wherein the data center is configured to provide to the employer access to the multimedia-formatted information.

15. The system of claim 14, wherein the multimedia-formatted information includes an audiovisual recording of the employment seeker.

16. The system of claim 14, wherein the data center is configured to create an interactive interview presentation based on information provided by the employer.

17. The system of claim 16, wherein the station is configured to present the interactive interview presentation to the employment seeker.

18. The system of claim 14, wherein the data center is configured to provide controlled access to the multimedia-formatted information.

19. The system of claim 18, wherein the controlled access includes a password and a predefined website address.

20. A method for exchanging multimedia-formatted information between an employer and an employment seeker, the method comprising:
creating a first identifier that is specific to the employer;
creating an applicant profile account upon login of the employer and input of the second identifier;
creating a second identifier that is specific to the employment seeker and associated with the applicant profile account;
communicating the second identifier to the employment seeker; and
providing to the employment seeker access to a station to upload the multimedia-formatted information to the applicant profile account via a communications network upon login of the employment seeker and input of the second identifier.

21. The method of claim 20, wherein the multimedia-formatted information includes a video image of the employment seeker.

22. The method of claim 20, further comprising:
providing to the employer access to the multimedia-formatted information via a web link.

23. The method of claim 20, further comprising:
providing to the employer access to a web-based application to manage the applicant profile account.

24. A station to provide information regarding an employment seeker, comprising:
an audiovisual arrangement to receive an audiovisual image of the employment seeker; and
an arrangement to upload the audiovisual image of the employment seeker via a communications network to a database that is accessible to an employer.

25. The station of claim 24, wherein the audiovisual arrangement is configured to present a presentation and record the audiovisual image of the employment seeker.

26. The station of claim 25, wherein the presentation includes a teleprompter.

27. The station of claim 25, wherein the station is configured as a kiosk.

28. The station of claim 27, wherein the kiosk is configured as a desktop unit.

29. The system of claim 28, wherein the kiosk is configured to be self-operable by the employment seeker without assistance of a second party.
